(19) United States
(12) Patent Application Publication
(10) Pub. No.: US 2026/0303920 A1
(43) Pub. Date: Oct. 1, 2026

(54) DATA PROCESSING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Peiyao CHENG, Shenzhen (CN); Yongwen LIU, Shenzhen (CN); Haoran DING, Shenzhen (CN); Ziyue ZHENG, Shenzhen (CN); Shuyuan LI, Shenzhen (CN)

(21) Appl. No.: 19/677,842

(22) Filed: May 14, 2026

Related U.S. Application Data
(63) Continuation of application No. PCT/CN2025/078802, filed on Feb. 24, 2025.

(30) Foreign Application Priority Data
Mar. 6, 2024 (CN) 202410258376.6

(51) Int. Cl. H04N 21/4788; H04N 21/431; H04N 21/4784

(52) U.S. Cl. CPC H04N 21/4788; H04N 21/4316; H04N 21/4784

(57) ABSTRACT

A data processing method includes: displaying a media playback interface, the media playback interface being configured for playing multimedia data; displaying an interactive control when the multimedia data played on the media playback interface satisfies a first condition; and triggering display of at least one piece of first interactive information in response to a trigger operation on the interactive control.

### CROSS-REFERENCES TO RELATED APPLICATIONS

This application is a continuation application of PCT Patent Application No. PCT/CN2025/078802, filed on Feb. 24, 2025, which claims priority to Chinese Patent Application No. 202410258376.6, filed on Mar. 6, 2024, all of which is incorporated herein by reference in their entirety.

### FIELD OF THE TECHNOLOGY

The present disclosure relates to the field of computer technologies, and in particular, to a data processing method, a data processing apparatus, a computer device, a computer-readable storage medium, and a computer program product.

### BACKGROUND OF THE DISCLOSURE

Currently, in a playback scenario of multimedia data, if a viewer object wants to post interactive information, for example, the viewer object wants to post a comment expressing their opinions or emotional responses to the multimedia data, the viewer object needs to perform complex posting operations during the viewing process of the multimedia data. Specifically, the viewer object needs to first find an option for posting the interactive information, select the posting option to bring up an information input box, then manually enter content of the interactive information, and then confirm the submission before the interactive information can be posted. Such method for posting interactive information involves a series of cumbersome and complicated operations, resulting in low convenience and limited interactivity. In addition, the computer device must respond promptly to each operation (for example, outputting the posting option when the viewer object searches for the posting option, and outputting the information input box when the viewer object selects the posting option), to ensure that a posting process is successfully performed. This places high performance demands on the computer device.

### SUMMARY

One embodiment of the present disclosure provides a data processing method. The method is performed by a computer device. The method includes: displaying a media playback interface, the media playback interface being configured for playing multimedia data; displaying an interactive control when the multimedia data played on the media playback interface satisfies a first condition; and triggering display of at least one piece of first interactive information in response to a trigger operation on the interactive control.

Another embodiment of the present disclosure provides a computer device. The computer device includes one or more processors and a memory containing a computer program that, when being executed, causes the one or more processors to perform: displaying a media playback interface, the media playback interface being configured for playing multimedia data; displaying an interactive control when the multimedia data played on the media playback interface satisfies a first condition; and triggering display of at least one piece of first interactive information in response to a trigger operation on the interactive control.

Another embodiment of the present disclosure provides a non-transitory computer-readable storage medium containing a computer program that, when being executed, causes at least one processor to perform: displaying a media playback interface, the media playback interface being configured for playing multimedia data; displaying an interactive control when the multimedia data played on the media playback interface satisfies a first condition; and triggering display of at least one piece of first interactive information in response to a trigger operation on the interactive control.

### BRIEF DESCRIPTION OF THE DRAWINGS

FIG. 1 is a schematic diagram of a structure of a data processing system according to an embodiment of the present disclosure.

FIG. 2 is a schematic flowchart of a data processing method according to an embodiment of the present disclosure.

FIG. 3a is a schematic diagram of a media playback interface according to an embodiment of the present disclosure.

FIG. 3b is a schematic diagram of turning on and turning off display of interactive information according to an embodiment of the present disclosure.

FIG. 3c is a schematic diagram of displaying interactive information according to an embodiment of the present disclosure.

FIG. 3d is a schematic diagram of displaying interactive information in a flowing manner according to an embodiment of the present disclosure.

FIG. 3e is another schematic diagram of displaying interactive information in a flowing manner according to an embodiment of the present disclosure.

FIG. 3f is a schematic diagram of displaying an interactive control according to an embodiment of the present disclosure.

FIG. 3g is another schematic diagram of displaying an interactive control according to an embodiment of the present disclosure.

FIG. 4a is a schematic diagram of comparison between display of different first interactive information according to an embodiment of the present disclosure.

FIG. 4b is a schematic diagram of displaying first interactive information according to an embodiment of the present disclosure.

FIG. 4c is another schematic diagram of displaying first interactive information according to an embodiment of the present disclosure.

FIG. 4d is still another schematic diagram of displaying first interactive information according to an embodiment of the present disclosure.

FIG. 4e is yet another schematic diagram of displaying first interactive information according to an embodiment of the present disclosure.

FIG. 4f is a schematic diagram of displaying first interactive information according to an embodiment of the present disclosure.

FIG. 4g is a schematic diagram of displaying first interactive information and second interactive information according to an embodiment of the present disclosure.

FIG. 4h is a schematic diagram of displaying a quantity of pieces of first interactive information according to an embodiment of the present disclosure.

FIG. 5 is a schematic flowchart of another data processing method according to an embodiment of the present disclosure.

FIG. 6a is a schematic diagram of displaying a plurality of interactive controls according to an embodiment of the present disclosure.

FIG. 6b is another schematic diagram of displaying a plurality of interactive controls according to an embodiment of the present disclosure.

FIG. 6c is still another schematic diagram of displaying a plurality of interactive controls according to an embodiment of the present disclosure.

FIG. 7a is a schematic diagram of displaying information according to an embodiment of the present disclosure.

FIG. 7b is another schematic diagram of displaying information according to an embodiment of the present disclosure.

FIG. 7c is a schematic diagram of triggering display of information according to an embodiment of the present disclosure.

FIG. 7d is a schematic diagram of closing information according to an embodiment of the present disclosure.

FIG. 8a is a schematic diagram of dynamically adjusting displayed information according to an embodiment of the present disclosure.

FIG. 8b is another schematic diagram of dynamically adjusting displayed information according to an embodiment of the present disclosure.

FIG. 8c is still another schematic diagram of dynamically adjusting displayed information according to an embodiment of the present disclosure.

FIG. 9a is a schematic diagram of performing a data processing method according to an embodiment of the present disclosure.

FIG. 9b is a schematic diagram of performing another data processing method according to an embodiment of the present disclosure.

FIG. 9c is a schematic diagram of performing still another data processing method according to an embodiment of the present disclosure.

FIG. 10 is a schematic diagram of a structure of a data processing apparatus according to an embodiment of the present disclosure.

FIG. 11 is a schematic diagram of a structure of a computer device according to an embodiment of the present disclosure.

### DESCRIPTION OF EMBODIMENTS

Embodiments of the present disclosure provide a data processing method and apparatus, a device, and a storage medium. An exemplary data processing method includes: displaying a media playback interface configured for playing multimedia data; displaying an interactive control when the multimedia data played on the media playback interface satisfies a first condition; and triggering display of at least one piece of first interactive information in response to a trigger operation on the interactive control. The disclosed embodiments provide technical solutions to simplify an interactive information posting procedure, optimize a response mechanism of a computer device to reduce performance demands on the computer device, improve convenience of posting interactive information, and improve convenience of user interaction, and further improve user experience.

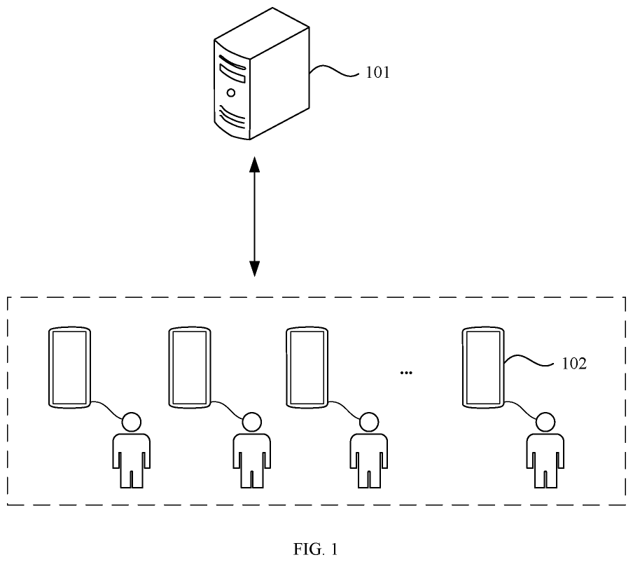

An embodiment of the present disclosure provides a data processing system. FIG. 1 is a schematic diagram of a structure of a data processing system according to an embodiment of the present disclosure. The data processing system may include a server 101 and at least one computer device 102. The server 101 may be an independent physical server, a server cluster or a distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. This is not limited according to the embodiments of the present disclosure. The computer device 102 may include but is not limited to a smartphone, a tablet computer, a notebook computer, a desktop computer, a smartwatch, an in-vehicle terminal, an intelligent wearable device, and the like. This is not limited according to the embodiments of the present disclosure. A display apparatus is usually configured in the computer device 102. The display apparatus may be a display, a display screen, a touchscreen, or the like. The touchscreen may be a touch control screen, a touch panel, or the like. The server 101 and the computer device 102 may be communicatively connected directly or indirectly through wired or wireless communication. This is not limited according to various embodiments of the present disclosure herein.

In one embodiment, a media playback application runs on the computer device 102, and the media playback application may be an application supporting playback of multimedia data. The multimedia data may include but is not limited to a video, live streaming data, streaming media, audio, an image, and the like. This is not limited according to various embodiments of the present disclosure. The video may be classified as a short video or a long video based on a video duration. For example, a video whose video duration is greater than or equal to a time value is referred to as a long video, a video whose video duration is less than the time value is referred to as a short video, and the video duration of the short video is shorter than the video duration of the long video. The foregoing “time value” may be set based on experience or an actual requirement. For example, if the time value is 20 minutes, a video whose video duration is greater than or equal to 20 minutes may be referred to as a long video, and a video whose video duration is less than 20 minutes may be referred to as a short video. The server 101 may be a background server providing service support for the media playback application. Schematically, the server 101 may deliver the multimedia data to the computer device 102, so that the computer device 102 may play the multimedia data.

The following describes a data processing procedure related to the data processing system shown in FIG. 1. The computer device 102 may display a media playback interface. For example, the media playback interface may be any interface of the media playback application. The media playback interface is configured for playing the multimedia data. An interactive control is displayed when the multimedia data played on the media playback interface satisfies a first condition. Display of at least one piece of first interactive information is triggered in response to a trigger operation on the interactive control. The multimedia data may be delivered by the server 101 to the computer device 102. As can be seen, the computer device may automatically output the interactive control in response to the multimedia data satisfying the first condition, a viewer object does not need to perform a series of cumbersome and complex operations, and the computer device does not need to consume performance resources to respond to the cumbersome and complex operations. This optimizes a response mechanism of the computer device, reduces a requirement on performance of the computer device, and reduces consumption of the performance resources of the computer device. In addition, automatic output of the interactive control effectively simplifies an interactive information posting procedure. Moreover, the outputted interactive control may further prompt and stimulate the viewer object to trigger the interactive control to post interactive information, increasing an interaction frequency. Interactive information can be conveniently posted by performing a trigger operation on the interactive control, improving convenience of posting interactive information improving interactivity, and further improving user experience.

The interactive information may be posted by a viewer object of the multimedia data in a process of viewing the multimedia data. Any piece of interactive information may include but is not limited to one or more of the following types of content information: a text, an emoji, an image, and audio. The first interactive information may be interactive information triggered to be generated by using the interactive control in this embodiment of the present disclosure. In addition, the multimedia data played on the media playback interface may further include second interactive information. The second interactive information may be interactive information that is triggered to be generated and displayed in another manner (that is, not by using the interactive control), for example, may be interactive information posted by a viewer object by invoking an information input box by selecting an interactive information posting option and then manually inputting content of the interactive information. The first interactive information and the second interactive information are both interactive information for the multimedia data, and “first” and “second” are merely used to distinguish between different generation triggering manners of the interactive information. Viewer objects of the multimedia data may interact with each other based on interactive information. For example, if a viewer object 1 of the multimedia data posts interactive information 1 in a process of viewing the multimedia data, the interactive information 1 may be displayed on a computer device of the viewer object 1, or may be synchronously pushed by the server 101 to a computer device of a viewer object 2 of the multimedia data for displaying. This can enrich interaction manners between viewer objects, enhance engagement and interactivity of the viewer objects, and improve viewing experience of the viewer objects. In some embodiments, one or more types of the first interactive information and the second interactive information may be synchronized based on a specific requirement setting. For example, in one embodiment, the second interactive information posted by the viewer object is synchronized, but the first interactive information is not synchronized. For another example, in another embodiment, the first interactive information and the second interactive information posted by the viewer object are both synchronized.

The interactive information may be displayed in a bullet comment form. In this case, the interactive information may be referred to as bullet comment information. The bullet comment information is real-time interactive comment information, and is usually presented across a screen. The bullet comment information is restricted by a flow trajectory. The interactive information may be displayed on the media playback interface in a flowing manner based on a flow trajectory. A flowing display manner may be designed as required. For example, the flowing display manner may include moving display and static display. A trajectory shape, a trajectory size, a trajectory location, and the like of the flow trajectory may all be designed as required.

An interface presentation of related data (for example, the multimedia data and the interactive information) when the related data is displayed on the media playback interface may be designed as required. All interface presentations that can implement the data processing method provided in the embodiments of the present disclosure shall fall within the protection scope of the embodiments of the present disclosure. In this embodiment, during example application of collection and processing of data (for example, the interactive information) related to the viewer object, an informed consent or individual consent of a personal information subject needs to be obtained in strict accordance with the requirements of laws and regulations, and a subsequent data use and processing behavior is carried out within the scope of authorization of laws and regulations and the personal information subject.

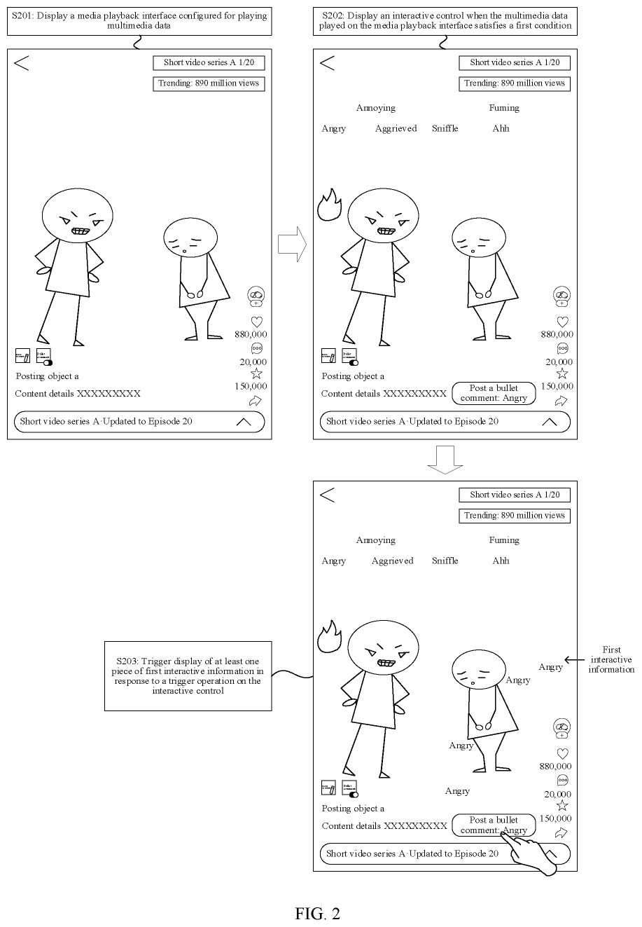

FIG. 2 is a schematic flowchart of a data processing method according to an embodiment of the present disclosure. The data processing method may be performed by a computer device, for example, may be performed by the computer device 102 in the data processing system shown in FIG. 1 alone, or may be performed by the computer device 102 with an assistance of the server 101 in the data processing system shown in FIG. 1. The data processing method may include the following operations S201 to S203.

S201: Display a media playback interface.

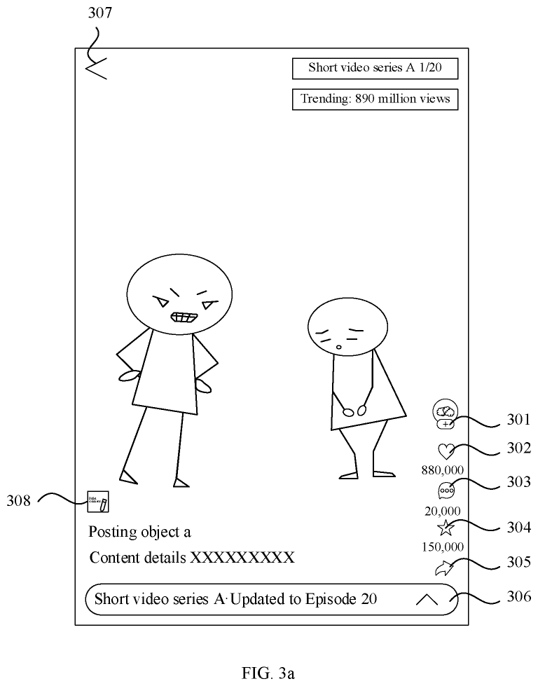

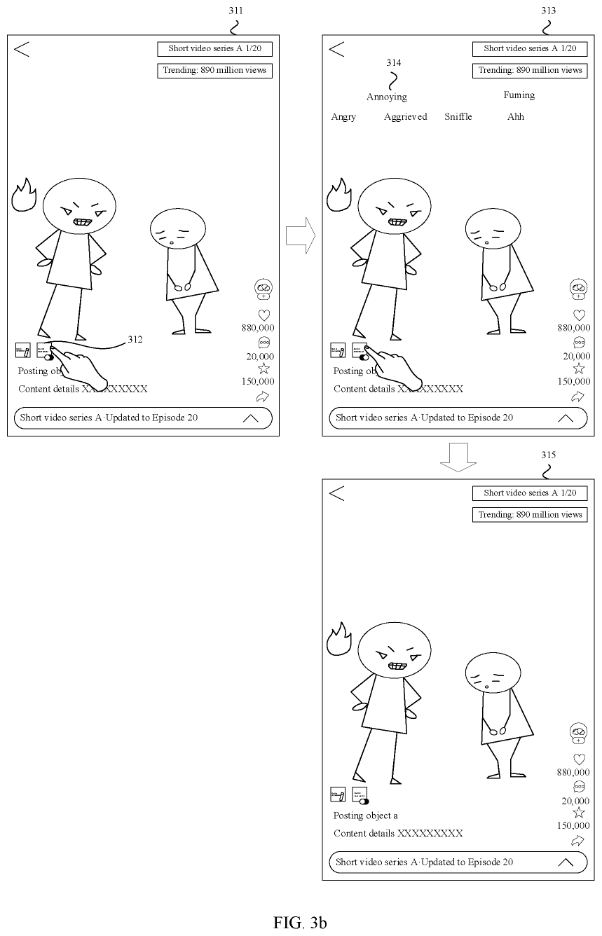

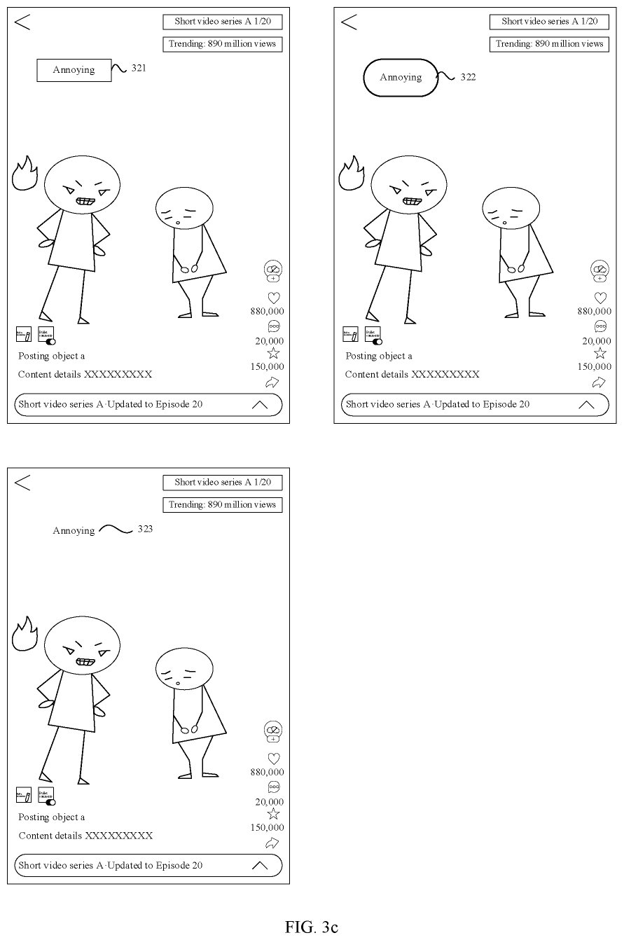

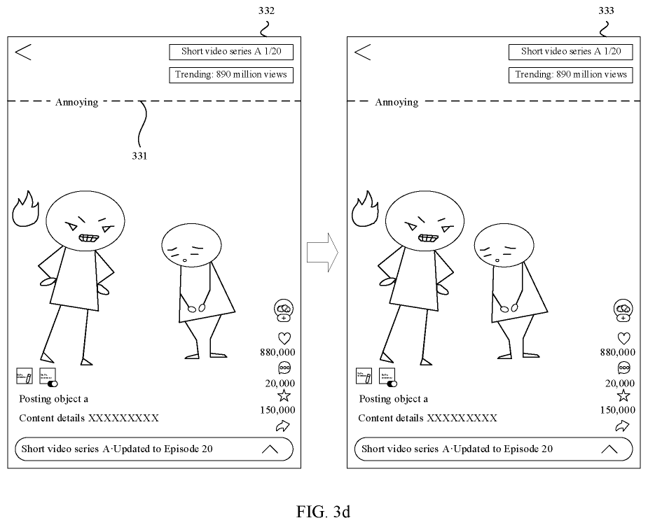

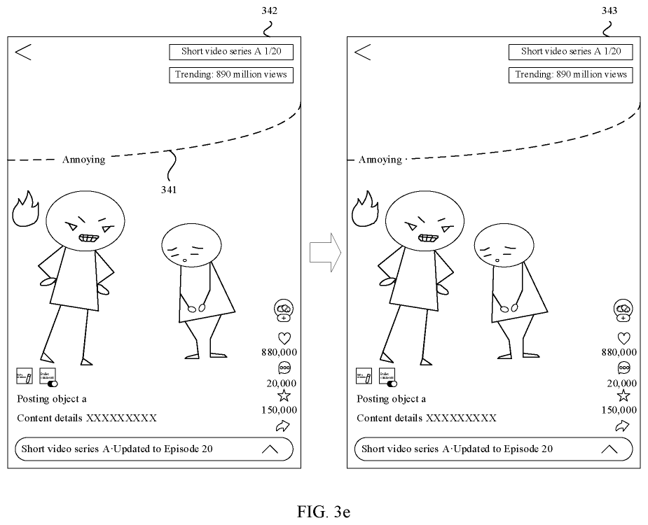

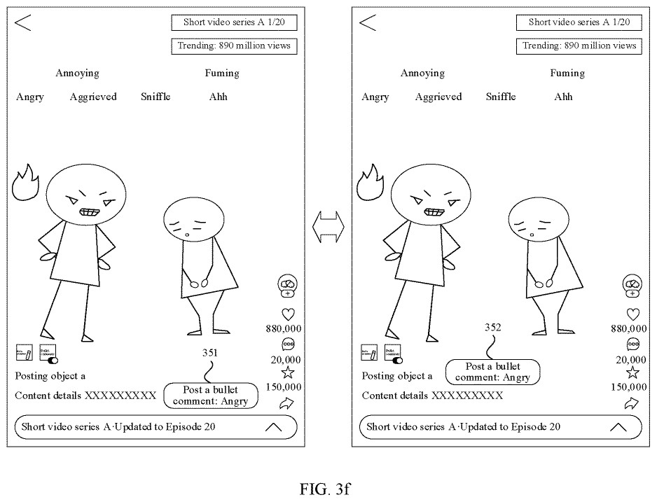

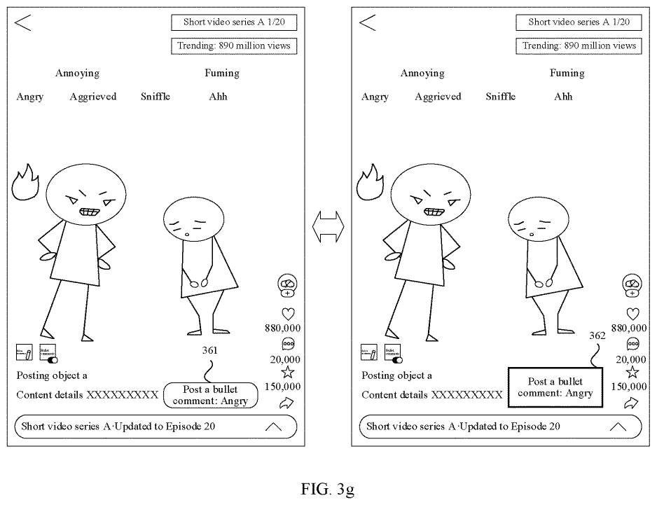

The media playback interface is configured for playing multimedia data. Schematically, the media playback interface may be any interface that is of a media playback application running on a computer device and that is configured for playing the multimedia data. In this embodiment of the present disclosure, an example in which the multimedia data is a video is used. The video may include a live video, a short video, a long video, or the like. FIG. 3a is a schematic diagram of a media playback interface according to an embodiment of the present disclosure. The multimedia data (for example, the video) that is being played is displayed on the media playback interface.

In one embodiment, descriptive information of the multimedia data may be further displayed on the media playback interface. The descriptive information of the multimedia data is configured for describing the multimedia data that is being played. The descriptive information of the multimedia data includes but is not limited to one or more of the following information: a name of the multimedia data, playback information of the multimedia data, a posting object of the multimedia data, and details about content of the multimedia data. Schematically, the descriptive information of the multimedia data displayed on the media playback interface shown in FIG. 3a includes the name of the multimedia data (that is, Episode 1 of a short video series A (the short video series A includes 20 episodes)), the playback information of the multimedia data (for example, a quantity of views is 8.9 billion), and the posting object of the multimedia data being a posting object a.

In one embodiment, media interaction status information of the multimedia data may be further displayed on the media playback interface. The media interaction status information is configured for describing an interaction status between a viewer object and the multimedia data. The media interaction status information may include but is not limited to one or more of the following information: a quantity of likes on the multimedia data, a quantity of comments on the multimedia data, and a quantity of favorites on the multimedia data. Schematically, the media interaction status information displayed on the media playback interface shown in FIG. 3a includes: the quantity of likes on the multimedia data is 880,000, the quantity of comments on the multimedia data is 20,000, and the quantity of favorites on the multimedia data is 150,000.

In one embodiment, various controls configured for interacting with the multimedia data may be further displayed on the media playback interface, for example, may include a follow control (which may be configured for triggering the posting object of the multimedia data to be followed), a like control (which may be configured for triggering a like operation on the multimedia data), a comment control (which may trigger a comment operation on the multimedia data), a favorite control (which may trigger a favorite operation on the multimedia data), a share control (which may be configured to trigger a share operation on the multimedia data), and the like. Schematically, FIG. 3a shows a follow control 301, a like control 302, a comment control 303, a favorite control 304, and a share control 305.

In one embodiment, a media switching control (configured for triggering switching of the multimedia data) may be further displayed on the media playback interface. Schematically, FIG. 3a shows a media switching control 306. When the media switching control 306 is triggered, a candidate option of multimedia data to which the multimedia data that is being played can be switched (for example, a candidate option corresponding to each episode of the short video series A) may be displayed on the media playback interface. When one candidate option is selected, the multimedia data that is being played is switched to multimedia data corresponding to the selected candidate option on the media playback interface (for example, when a candidate option corresponding to Episode 2 is selected, the multimedia data that is being played is switched from Episode 1 to Episode 2 of the short video series A). A control operation in this embodiment of the present disclosure may include but is not limited to one or more of operations such as a tap operation, a double-tap operation, a touch-and-hold operation, and a gesture operation (for example, a circle drawing operation or a slide operation). The control operation may be designed as required, and is not limited according to various embodiments of the present disclosure. In one embodiment, an exit control (configured for triggering an exit from the media playback interface) may be further displayed on the media playback interface. Schematically, FIG. 3a shows an exit control 307.

In one embodiment, a bullet comment posting control (which may be configured for triggering posting of interactive information for the multimedia data) may be further displayed on the media playback interface. The interactive information posted by using the bullet comment posting control may be referred to as second interactive information. Schematically, referring to FIG. 3a, the bullet comment posting control may be indicated by a reference numeral 308. If the bullet comment posting control 308 is triggered, a bullet comment input region and a posting confirmation control may be displayed on the media playback interface. When the posting confirmation control is triggered, the second interactive information may be posted and displayed on the media playback interface. Content information of the posted second interactive information is content information input by the viewer object in the bullet comment input region. For example, the viewer object inputs a text “Annoying” in the bullet comment input region, and second interactive information whose content information is the text “Annoying” may be displayed on the media playback interface.

In one embodiment, in a process of playing the multimedia data, if the multimedia data is in a bullet comment on state, the computer device may display the interactive information on the media playback interface; or if the multimedia data is in a bullet comment off state, the computer device does not display the interactive information on the media playback interface. In one embodiment, in the process of playing the multimedia data, the computer device may enter the bullet comment on state in response to a bullet comment turn-on operation, and display the interactive information on the media playback interface; and enter the bullet comment off state in response to a bullet comment turn-off operation, and stop displaying the interactive information. Operation forms of the bullet comment turn-on operation and the bullet comment turn-off operation may be set based on a specific requirement. For example, a bullet comment switch control may be displayed on the media playback interface, the bullet comment turn-on operation may include a trigger operation performed on the bullet comment switch control when the multimedia data is in the bullet comment off state, and the bullet comment turn-off operation may include a trigger operation performed on the bullet comment switch control when the multimedia data is in the bullet comment on state. FIG. 3b is a schematic diagram of turning on and turning off display of interactive information according to an embodiment of the present disclosure. A media playback interface indicated by a reference numeral 311 is in the bullet comment off state, and the bullet comment switch control may be indicated by a reference numeral 312. If the bullet comment switch control is triggered, display of content displayed in a bullet comment form, including display of the interactive information, is turned on. A media playback interface in the bullet comment on state may be indicated by a reference numeral 313, on which the second interactive information is displayed. One piece of second interactive information may be indicated by a reference numeral 314. If the bullet comment switch control is triggered again, display of the content displayed in the bullet comment form, including display of the interactive information, is turned off. A media playback interface in the bullet comment off state may be indicated by a reference numeral 315. For example, the bullet comment turn-on operation may further include a double-tap operation, a tap operation, and a specific gesture operation (for example, a circle drawing operation or a triangle drawing operation) on the multimedia data that is being played. The bullet comment turn-off operation may alternatively be a double-tap operation, a tap operation, and a specific gesture operation (for example, a circle drawing operation or a triangle drawing operation) on the multimedia data that is being played.

In one embodiment, the media playback application may further support the viewer object in configuring a style of the posted interactive information. The style of the interactive information may include but is not limited to one or more of the following: a display size, a display color, and a display shape. The display shape may indicate a shape of an information box configured for carrying the content information. For example, when the content information is a text, the display shape may indicate a shape of a text box configured for carrying the text. The display color may indicate a color of the information box and a color of the content information. For example, when the content information is the text, the display color may indicate a color of the text box and a color of the text. The display size may indicate a size of the information box and a size of the content information. For example, when the content information is the text, the display size may indicate a size of the text box and a size of the text. For example, if content information of a piece of interactive information is a text, and the text is “Annoying”, an example in which the interactive information is displayed on the media playback interface is used. FIG. 3c is a schematic diagram of displaying interactive information according to an embodiment of the present disclosure. Interactive information of a first style is indicated by a reference numeral 321, interactive information of a second style is indicated by a reference numeral 322, and interactive information of a third style is indicated by a reference numeral 323. A display shape and a display size of the interactive information indicated by the reference numeral 322 are different from those of the interactive information indicated by the reference numeral 321. A size of content information in the display size of the interactive information indicated by a reference numeral 323 is the same as a size of content information in the display size of the interactive information indicated by the reference numeral 321. A color of the content information in a display color of the interactive information indicated by the reference numeral 323 is the same as a color of the content information in a display color of the interactive information indicated by the reference numeral 321. An information box in the display color of the interactive information indicated by the reference numeral 323 is transparent. In an implementation, the interactive information displayed on the media playback interface may not be carried based on an information box. When the interactive information is displayed in this manner, a display effect in a manner in which the information box is transparent can be achieved.

In one embodiment, any content displayed on the media playback interface in the bullet comment form is to be restricted by a flow trajectory. When a piece of content is displayed on the media playback interface in the bullet comment form, the content may be displayed on the media playback interface in a flowing manner based on a flow trajectory corresponding to the content. The flowing display manner may include moving display, static display, and the like. The flowing display manner may be designed as required. A trajectory shape, a trajectory size, a trajectory location, and the like of the flow trajectory corresponding to the content may be designed as required. The flow trajectory corresponding to the content may be displayed or may not be displayed on the media playback interface. This is not limited according to various embodiments of the present disclosure. This embodiment of the present disclosure is described by using an example in which the flow trajectory is not displayed. In one embodiment, when a piece of content is displayed on the media playback interface in the bullet comment form, a display duration of the content may be set based on a specific requirement. This is not limited according to various embodiments of the present disclosure. For example, if content information of a piece of interactive information is a text, and the text is “Annoying”, an example in which the interactive information is displayed on the media playback interface in a flowing manner is used. FIG. 3d is a schematic diagram of displaying interactive information in a flowing manner according to an embodiment of the present disclosure. The flowing display manner of the interactive information is moving display. The flow trajectory may be indicated by a reference numeral 331 (the flow trajectory shown in the figure in the present disclosure is merely for ease of viewing, and the computer device may display or may not display the flow trajectory during an actual processing process), and is a straight trajectory. A media playback interface on which the interactive information is displayed when the multimedia data is played to a specific playback time is indicated by a reference numeral 332, and a media playback interface on which the interactive information is displayed at a specific playback time after the multimedia data is played to the playback time is indicated by a reference numeral 333. In other words, during this time period, the interactive information is displayed based on the flow trajectory indicated by the reference numeral 331 in a manner of moving from a display location on the media playback interface indicated by the reference numeral 332 to a display location on the media playback interface indicated by the reference numeral 333. If the flowing display manner of the interactive information is static display, within a display duration of the interactive information, a display location of the interactive information on the media display interface may be a location on the flow trajectory indicated by the reference numeral 331, and the display location remains unchanged. For example, within the display duration of the interactive information, the interactive information may have a same display effect indicated by the numeral reference 332. FIG. 3e is another schematic diagram of displaying interactive information in a flowing manner according to an embodiment of the present disclosure. The flowing display manner of the interactive information is moving display. The flow trajectory may be indicated by a reference numeral 341, and is a curved trajectory. A media playback interface on which the interactive information is displayed when the multimedia data is played to a specific playback time is indicated by a reference numeral 342, and a media playback interface on which the interactive information is displayed at a specific playback time after the multimedia data is played to the playback time is indicated by a reference numeral 343.

S202: Display an interactive control when the multimedia data played on the media playback interface satisfies a first condition.

In one embodiment, the interactive control may include quick comment content. A style and a layout of the interactive control may be designed based on a specific requirement, and are not limited according to various embodiments of the present disclosure.

In one embodiment, that the multimedia data played on the media playback interface satisfies the first condition may include at least one of the following: the multimedia data includes preset media content, and the multimedia data is played into a preset playback time. In other words, the interactive control may be displayed when the multimedia data is played to the preset media content, or the interactive control may be displayed when the multimedia data is played into the preset playback time. A display duration of the interactive control may be set based on a specific requirement.

The preset media content may be designed as required. The quick comment content may be designed as required. The quick comment content included in the interactive control may be adapted to the preset media content. In one embodiment, the preset media content may be media content that expresses a target emotion. In this case, the quick comment content adapted to the preset media content may be comment content configured for expressing the target emotion. The target emotion may be designed as required, and is, for example, joy, sadness, or anger. An example in which the multimedia data is a video is used. If the target emotion is anger, when the multimedia video is played to video content that expresses anger, the interactive control is outputted on the media playback interface, and the quick comment content in the interactive control may be comment content configured for expressing anger, for example, may be a text “Angry”, “So angry”, or “Fuming”. In another embodiment, the preset media content may be media content that expresses a target theme, and the quick comment content adapted to the preset media content may be comment content configured for expressing the target theme. The target theme may be designed as required, and may be, for example, a Dragon Boat Festival theme, a Chinese Valentine's Day theme, or a Spring Festival theme. An example in which the multimedia data is a video is used. If the target theme is the Dragon Boat Festival theme, when the multimedia video is played to video content that expresses the Dragon Boat Festival theme (for example, video content including a scene of making dumplings, eating dumplings, rowing a dragon boat, or the like), the interactive control is outputted on the media playback interface, and the quick comment content in the interactive control may be configured for expressing the Dragon Boat Festival theme, and may be, for example, a text “Good luck for Dragon Boat Festival”, “Sweet dumplings are the best”, and “Meat dumplings are the best”. In another embodiment, the preset media content may be media content that includes a target keyword, and the quick comment content may be the target keyword. The target keyword may be set based on a specific requirement. For example, the target keyword may be a text “angry”, “sad”, or “furious”. An example in which the multimedia data is a video is used. That the video includes the target keyword may mean that a subtitle of the video includes the target keyword, or audio corresponding to the video includes a voice corresponding to the target keyword.

The preset playback time may be designed as required. The quick comment content may be designed as required. The quick comment content included in the interactive control may be adapted to the preset playback time. The preset playback time may support setting of a start time, an end time, a duration, and the like. For example, the preset playback time may be set as follows: the start time is a playback start time point of the multimedia data, and the duration is 10 seconds. In this case, when the multimedia data is played into the preset playback time, the interactive control is outputted on the media playback interface, and the quick comment content in the interactive control may be, for example, “Showtime” or “Live now”. For another example, the preset playback time may be set as follows: the start time is 10 p.m. of a day, and the duration is 10 seconds. In this case, when the multimedia data is played into the preset playback time, the interactive control is outputted on the media playback interface, and the quick comment content in the interactive control may be, for example, “It is deep at night”.

In one embodiment, a display manner of the interactive control may include at least one of the following: displaying the interactive control on the media playback interface in the bullet comment form; displaying the interactive control at any fixed location on the media playback interface; displaying the interactive control dynamically at different locations on the media playback interface; displaying the interactive control by using an interface independent of the media playback interface; or displaying the interactive control in a window located on the media playback interface. The diversified display manners of the interactive control can enhance display interestingness of the interactive control and improve user experience. A related process of displaying the interactive control on the media playback interface in the bullet comment form is similar to the foregoing related process of displaying the interactive information on the media playback interface in the bullet comment form, and details are not described herein again. When the interactive control is displayed at the fixed location, the fixed location for display may be set based on a specific requirement, and is not limited according to various embodiments of the present disclosure. When the interactive control is displayed dynamically at different locations on the media playback interface, each location at which the interactive control needs to be displayed may be set based on a specific requirement, and a duration for which the interactive control needs to be displayed at each location may also be set based on a specific requirement. When the interactive control is displayed in the window located on the media playback interface, a style and a layout of the corresponding window may be set based on a specific requirement, and are not limited according to various embodiments of the present disclosure. For ease of description, in this embodiment of the present disclosure, an example in which the interactive control is displayed at the fixed location is used subsequently. FIG. 3f is a schematic diagram of displaying an interactive control according to an embodiment of the present disclosure. The interactive control is displayed at the fixed location. A fixed location for displaying an interactive control indicated by a reference numeral 351 is different from a fixed location for displaying an interactive control indicated by a reference numeral 352. Quick comment content included in the interactive control is the text “Angry”. The style of the interactive control may also be designed based on a specific requirement. For example, different display shapes, different display colors, and different display sizes may be used based on the design. FIG. 3g is another schematic diagram of displaying an interactive control according to an embodiment of the present disclosure. A style of an interactive control indicated by a reference numeral 361 is different from a style of an interactive control indicated by a reference numeral 362.

S203: Trigger display of at least one piece of first interactive information in response to a trigger operation on the interactive control.

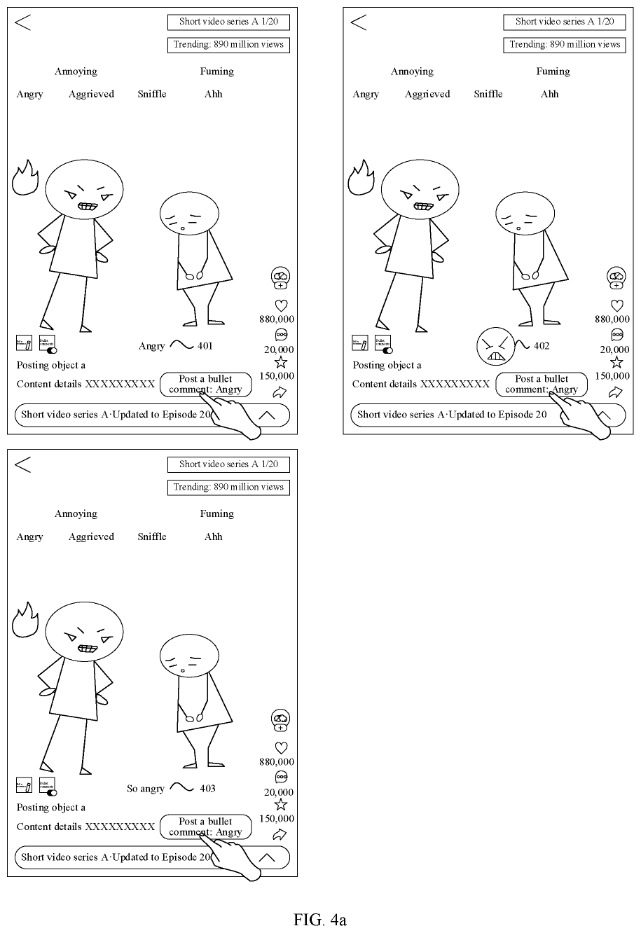

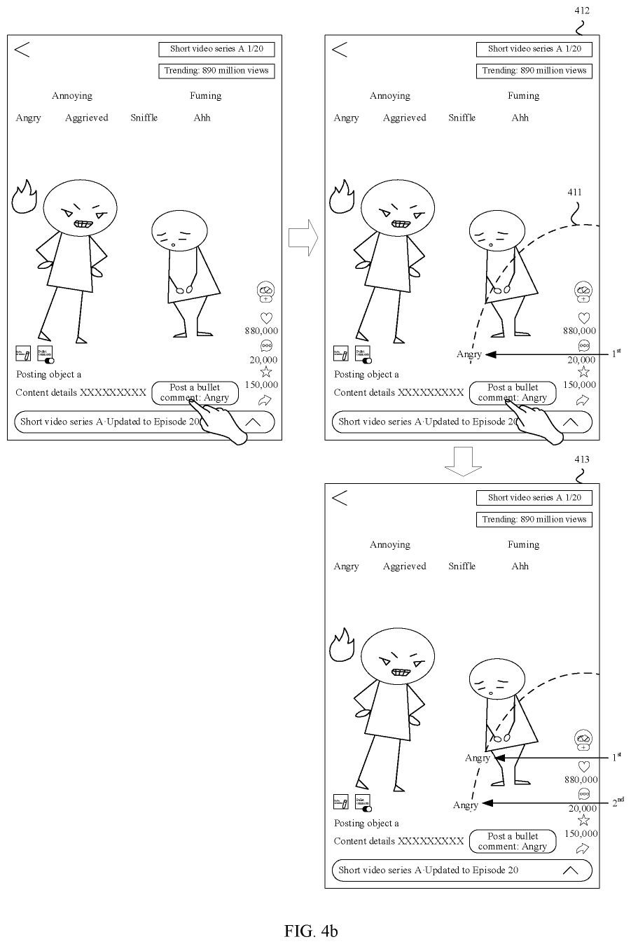

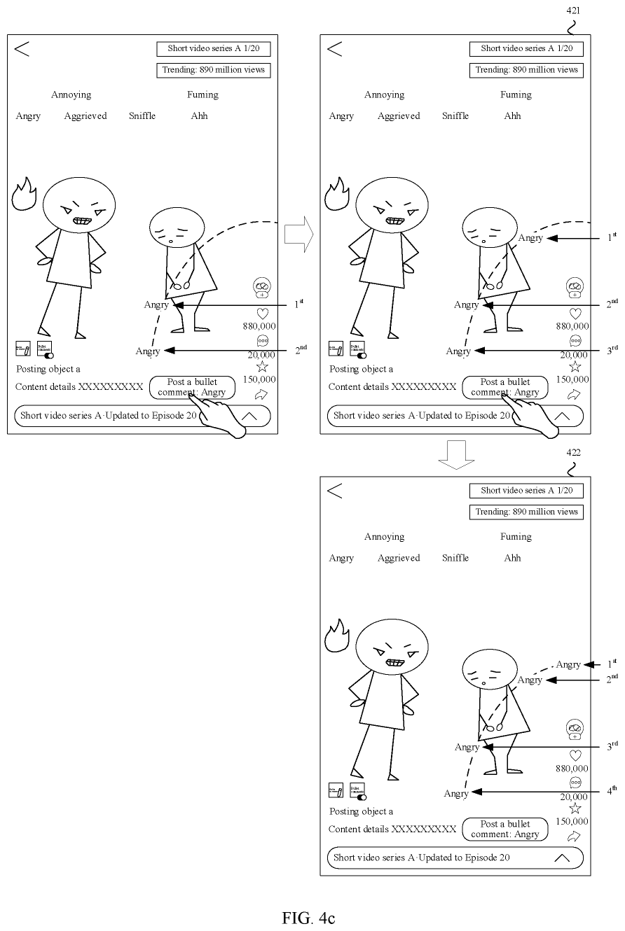

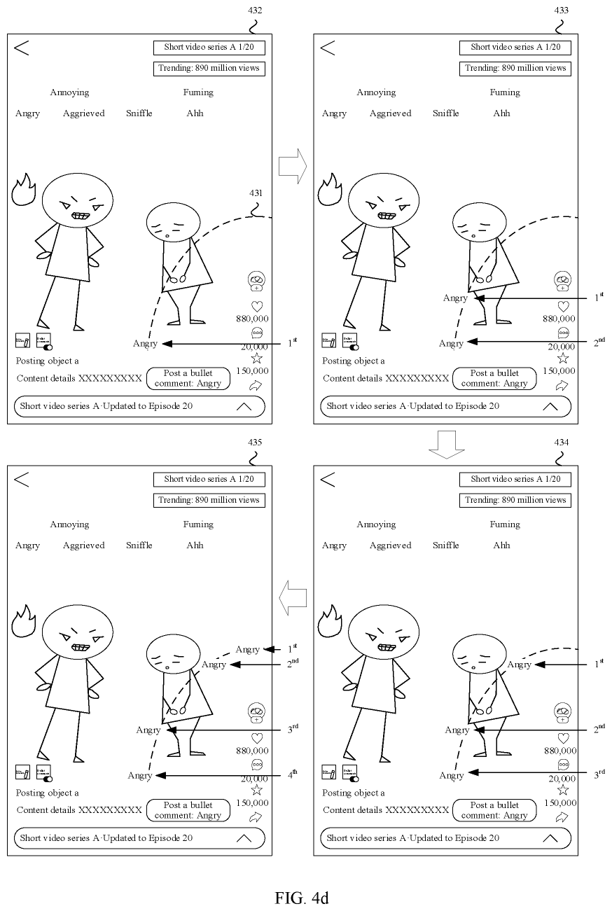

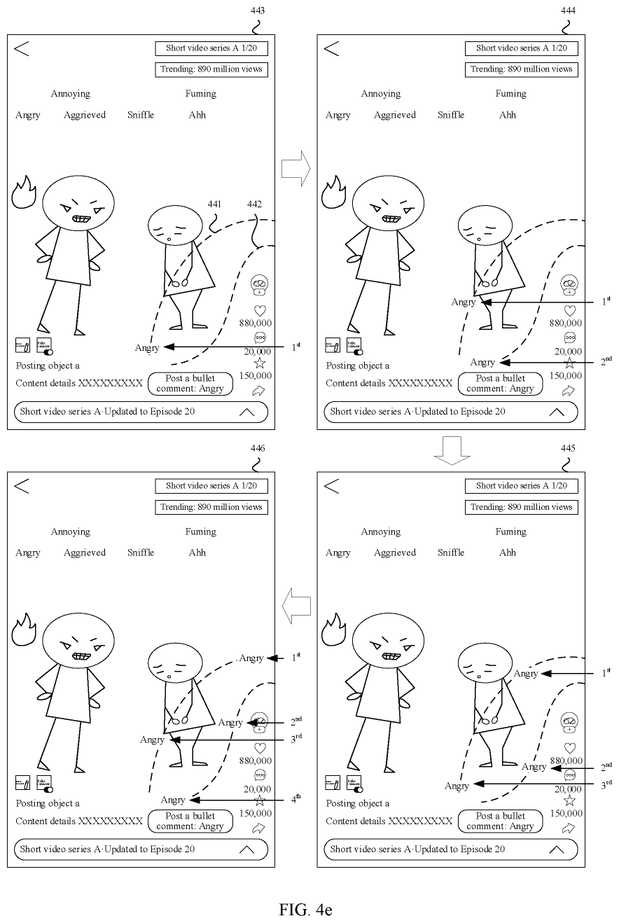

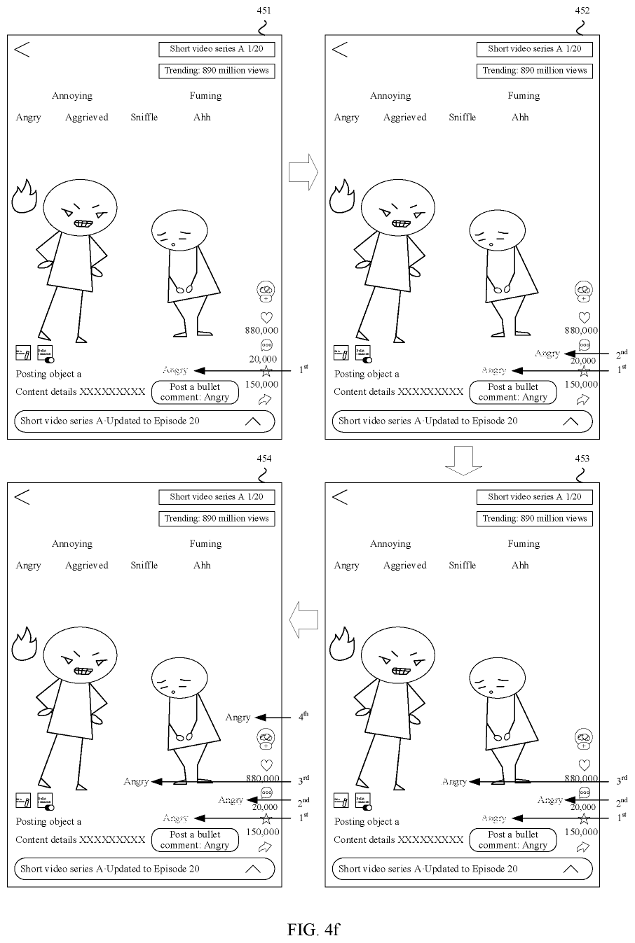

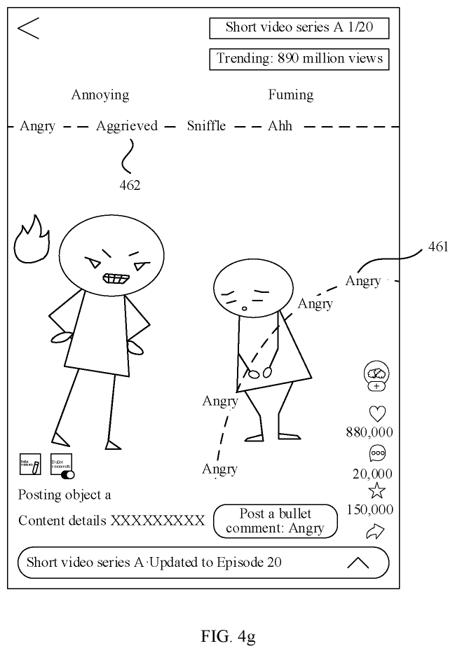

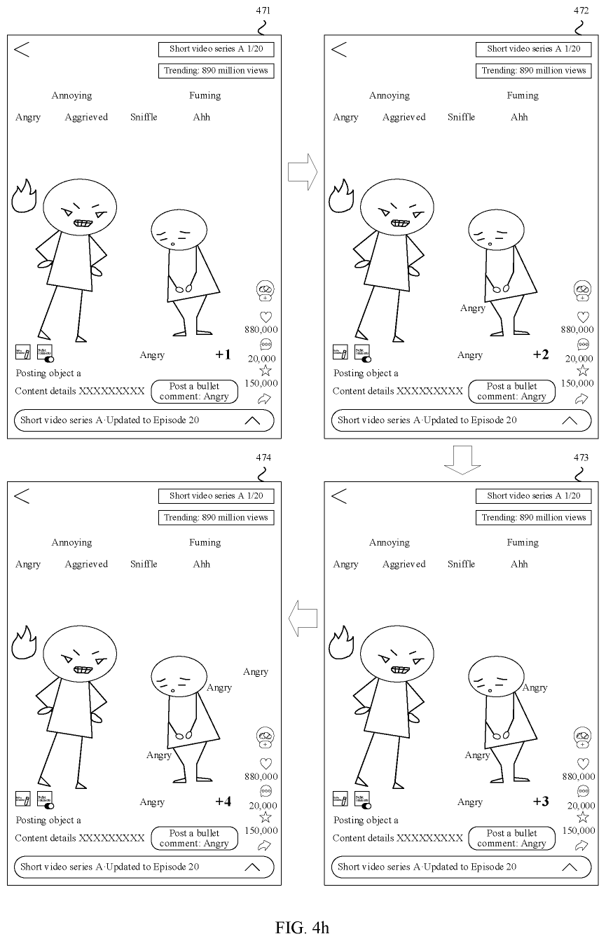

In one embodiment, the interactive control includes the quick comment content, the first interactive information includes content information adapted to the quick comment content, and the content information includes one or more of the following: a text, an emoji, an image, and audio. In some embodiments, being adapted herein may include any one of the following: being the same, being the same in semantics but different in format, and being similar in semantics. For example, FIG. 4a is a schematic diagram of comparison between display of different first interactive information according to an embodiment of the present disclosure. If the quick comment content is the text “Angry”, the content information adapted to the quick comment content may be the quick comment content, that is, the text “Angry” (indicated by 401 in FIG. 4a); may be content information that is the same in semantics as but different in format from the quick comment content, for example, may be an expression (indicated by 402 in FIG. 4a) that expresses anger semantics, an image that expresses the anger semantics, or audio that expresses the anger semantics; or may be content information similar to the quick comment content in semantics, for example, may be the text “So angry” or “Very angry” (indicated by 403 in FIG. 4a). According to this embodiment of the present disclosure, display interestingness of the first interactive information posted by triggering the interactive control can be enhanced, and the user experience can be improved.

In one embodiment, a process in which the computer device triggers display of the at least one piece of first interactive information in response to the trigger operation on the interactive control may include at least one of the following implementations: triggering display of one piece of first interactive information each time a trigger operation is performed on the interactive control; triggering, when an operation duration of the trigger operation performed on the interactive control is T, display of one piece of first interactive information each time a time period t is reached within the operation duration T, t and T being both positive integers, and t being less than T; triggering display of one piece of first interactive information when an operation duration of the trigger operation performed on the interactive control is greater than a first duration threshold; or triggering display of one piece of first interactive information each time the interactive control is moved to a new location point when the trigger operation is performed on the interactive control and the interactive control is moved along the media playback interface during the trigger operation. Herein, t may be set based on a specific requirement. For example, t is set to two seconds. In this case, display of one piece of first interactive information is triggered each time the operation duration of the trigger operation performed on the interactive control reaches two seconds. The first duration threshold may be set based on a specific requirement.

In one embodiment, each piece of first interactive information triggered (generated) by using the interactive control is displayed sequentially on the media playback interface based on a generation sequence. In one embodiment, the first interactive information may be displayed in a flowing manner based on a first flow trajectory. A trajectory shape, a trajectory size, a trajectory location, and the like of the first flow trajectory may all be designed as required. In one embodiment, the media playback application may provide at least one first flow trajectory. For any piece of first interactive information generated, the computer device may select one first flow trajectory from the at least one first flow trajectory, and display the corresponding first interactive information on the media playback interface in a flowing manner based on the selected first flow trajectory. For example, in a selection manner, the computer device may randomly select a first flow trajectory from the at least one first flow trajectory for any piece of first interactive information generated. In another selection manner, the computer device may sequentially select the at least one first flow trajectory in turn for each piece of first interactive information generated. For example, the media playback application provides two first flow trajectories, the 1^{st} first flow trajectory is selected for flowing display of the 1^{st} piece of first interactive information generated, the 2^{nd} first flow trajectory is selected for flowing display of the 2^{nd} piece of first interactive information generated, the 1^{st} first flow trajectory is selected for flowing display of the 3^{rd} piece of first interactive information generated, the 2^{nd} first flow trajectory is selected for flowing display of the 4^{th} piece of first interactive information generated, and so on. In yet another selection manner, the computer device may select a same first flow trajectory from the at least one first flow trajectory for each piece of first interactive information generated.

In one embodiment, in a process of displaying any piece of first interactive information in a flowing manner based on a corresponding first flow trajectory (that is, within a display duration corresponding to the first interactive information), a style of the first interactive information may remain unchanged, or may change dynamically. Styles of pieces of first interactive information triggered (generated) by using the interactive control may be the same or different. A plurality of pieces of first interactive information may change dynamically in a same manner or in different manners. This is not limited according to various embodiments of the present disclosure. In this embodiment of the present disclosure, the computer device may display the first interactive information in a plurality of display manners, enhancing the display interestingness of the first interactive information and improving the user experience.

The following uses the trigger manner of triggering display of one piece of first interactive information is triggered each time a trigger operation is performed on the interactive control as an example, to describe a related process of displaying, sequentially on the media playback interface based on the generation sequence of the first interactive information, each piece of first interactive information triggered (generated) by using the interactive control.

FIG. 4b is a schematic diagram of displaying first interactive information according to an embodiment of the present disclosure. As shown in FIG. 4b, each piece of first interactive information triggered (generated) by using the interactive control is displayed in a flowing manner based on a same first flow trajectory. The first flow trajectory may be indicated by a reference numeral 411, and a style of each piece (each item) of first interactive information in a flowing display process is correspondingly the same and remains unchanged. If a first trigger operation is performed on the interactive control, the 1^{st} piece of first interactive information is displayed on the media playback interface in a flowing manner based on the first flow trajectory. In this case, a media playback interface displaying the first interactive information may be indicated by a reference numeral 412, and displays one piece of first interactive information. If a second trigger operation is performed on the interactive control, the 2^{nd} piece of first interactive information is displayed on the media playback interface in a flowing manner based on the first flow trajectory. In this case, a media playback interface displaying the first interactive information may be indicated by a reference numeral 413, and displays two pieces of first interactive information. FIG. 4c is another schematic diagram of displaying first interactive information according to an embodiment of the present disclosure. If a third trigger operation is performed on the interactive control, the 3^{rd} piece of first interactive information is displayed on the media playback interface in a flowing manner based on the first flow trajectory. In this case, a media playback interface displaying the first interactive information may be indicated by a reference numeral 421, and displays three pieces of first interactive information. If a fourth trigger operation is performed on the interactive control, the 4^{th} piece of first interactive information is displayed on the media playback interface in a flowing manner based on the first flow trajectory. In this case, a media playback interface displaying the first interactive information may be indicated by a reference numeral 422, and displays four pieces of first interactive information.

FIG. 4d is still another schematic diagram of displaying first interactive information according to an embodiment of the present disclosure. As shown in FIG. 4d, each piece of first interactive information triggered (generated) by using the interactive control is displayed in a flowing manner based on a same first flow trajectory. The first flow trajectory may be indicated by a reference numeral 431, and a style of each piece (each item) of first interactive information in a flowing display process changes dynamically in a same manner. The dynamic change indicates that a size of content information in a display size of the first interactive information gradually increases in the flowing display process. A media playback interface displaying first interactive information after a first trigger operation may be indicated by a reference numeral 432, and displays one piece of first interactive information. A media playback interface displaying first interactive information after a second trigger operation may be indicated by a reference numeral 433, and displays two pieces of first interactive information. A media playback interface displaying first interactive information after a third trigger operation may be indicated by a reference numeral 434, and displays three pieces of first interactive information. A media playback interface displaying first interactive information after a fourth trigger operation may be indicated by a reference numeral 435, and displays four pieces of first interactive information.

FIG. 4e is yet another schematic diagram of displaying first interactive information according to an embodiment of the present disclosure. As shown in FIG. 4e, the media playback application provides two first flow trajectories. The 1^{st} first flow trajectory and the 2^{nd} first flow trajectory are respectively indicated by reference numerals 441 and 442. A first flow trajectory corresponding to each piece of first interactive information triggered (generated) by using the interactive control is selected in a manner of sequentially selecting the first flow trajectories provided by the media playback application in turn. The 1^{st} first flow trajectory is selected for flowing display of the 1^{st} piece of first interactive information generated, the 2^{nd} first flow trajectory is selected for flowing display of the 2^{nd} piece of first interactive information generated, the 1^{st} first flow trajectory is selected for the 3^{rd} piece of first interactive information generated, the 2^{nd} first flow trajectory is selected for the 4^{th} piece of first interactive information generated, and so on. A style of each piece (each item) of first interactive information in a flowing display process changes dynamically in a same manner. The dynamic change indicates that a size of content information in a display size of the first interactive information gradually increases in the flowing display process. A media playback interface displaying first interactive information after a first trigger operation may be indicated by a reference numeral 443, and displays one piece of first interactive information. A media playback interface displaying first interactive information after a second trigger operation may be indicated by a reference numeral 444, and displays two pieces of first interactive information. A media playback interface displaying first interactive information after a third trigger operation may be indicated by a reference numeral 445, and displays three pieces of first interactive information. A media playback interface displaying first interactive information after a fourth trigger operation may be indicated by a reference numeral 446, and displays four pieces of first interactive information.

In one embodiment, a quantity of pieces of first interactive information is N, N being an integer greater than 1. Herein, the quantity of pieces of first interactive information is configured for indicating a quantity of pieces of first interactive information triggered (generated) by using the interactive control on the computer device. Based on the foregoing situation, a process in which the computer device triggers display of the at least one piece of first interactive information in response to the trigger operation on the interactive control may be: displaying, in response to the trigger operation on the interactive control, the N pieces of first interactive information sequentially in different display manners based on a generation sequence of the N pieces of first interactive information, the different display manners including at least one of the following: display sizes of different pieces of first interactive information are different, display colors of different pieces of first interactive information are different, display locations of different pieces of first interactive information are different, flow trajectories of different pieces of first interactive information during flowing display are different, display shapes of different pieces of first interactive information are different, and display durations of different pieces of first interactive information are different. For example, if four pieces of first interactive information are triggered (generated) by using the interactive control, that is, N=4, FIG. 4f is a schematic diagram of displaying first interactive information according to an embodiment of the present disclosure. Display sizes of different pieces of first interactive information are different, display colors of different pieces of first interactive information are different, display locations of different pieces of first interactive information are different, and the location of each piece of first interactive information remains unchanged during display. A media playback interface displayed after the 1^{st} piece of first interactive information is generated may be indicated by a reference numeral 451, and displays one piece of first interactive information. A media playback interface displayed after the 2^{nd} piece of first interactive information is generated may be indicated by a reference numeral 452, and displays two pieces of first interactive information. A media playback interface displayed after the 3^{rd} piece of first interactive information is generated may be indicated by a reference numeral 453, and displays three pieces of first interactive information. A media playback interface displayed after the 4^{th} piece of first interactive information is generated may be indicated by a reference numeral 454, and displays four pieces of first interactive information. The foregoing is merely an example description of a display manner of each piece of first interactive information triggered (generated) by using the interactive control. In an actual service scenario, a plurality of display manners may be obtained through selection and combination or another display manner may be designed as required. This is not limited according to various embodiment of the present disclosure.

In one embodiment, the first interactive information is displayed in a flowing manner based on the first flow trajectory, the multimedia data further includes the second interactive information, the second interactive information is interactive information that is not triggered by using the interactive control, and the second interactive information is displayed in a flowing manner based on a second flow trajectory, the first flow trajectory being different from the second flow trajectory. FIG. 4g is a schematic diagram of displaying first interactive information and second interactive information according to an embodiment of the present disclosure. A piece of first interactive information may be indicated by a reference numeral 461, and content information of the first interactive information is the text “Angry”. A piece of second interactive information may be indicated by a reference numeral 462, and content information of the second interactive information is a text “Aggrieved”.

In one embodiment, the computer device may further output the quantity of pieces of first interactive information triggered to be displayed. In some embodiments, the quantity of pieces of first interactive information may be displayed on the media playback interface in a bullet comment form. Alternatively, the quantity of pieces of first interactive information may be displayed at any fixed location on the media playback interface. Alternatively, the quantity of pieces of first interactive information may be displayed dynamically at different locations on the media playback interface. This may be set as required, and is not limited according to various embodiments of the present disclosure. In some embodiments, a style and a layout of the quantity of pieces of first interactive information may also be designed based on a specific requirement, and are not limited according to various embodiments of the present disclosure. If the quantity of pieces of first interactive information triggered to be displayed is 4, FIG. 4 h is a schematic diagram of displaying a quantity of pieces of first interactive information according to an embodiment of the present disclosure. A media playback interface displayed after the 1^{st} piece of first interactive information is generated may be indicated by a reference numeral 471, and a quantity of pieces of first interactive information is 1, and is specifically displayed as “+1”. A media playback interface displayed after the 2^{nd} piece of first interactive information is generated may be indicated by a reference numeral 472, and a quantity of pieces of first interactive information is 2, and is specifically displayed as “+2”. A media playback interface displayed after the 3^{rd} piece of first interactive information is generated may be indicated by a reference numeral 473, and a quantity of pieces of first interactive information is 3, and is specifically displayed as “+3”. A media playback interface displayed after the 4^{th} piece of first interactive information is generated may be indicated by a reference numeral 474, and a quantity of pieces of first interactive information is 4, and is specifically displayed as “+4”.

In one embodiment, the multimedia data may include a plurality of viewer objects, and the trigger operation on the interactive control is performed by a target viewer object in the plurality of viewer objects. In this case, a computer device of the target viewer object may push the at least one piece of first interactive information to another viewer object other than the target viewer object, for example, push the at least one piece of first interactive information to a computer device of the another viewer object, to synchronize the first interactive information posted by the target viewer object to the another viewer object. In one embodiment, interactive information posted by a viewer object at a playback progress of the multimedia data via a computer device may be transmitted to a server. After receiving the interactive information, the server may store the interactive information into a bullet comment pool, and may further push the interactive information to another viewer object (that is, transmit the interactive information to a computer device used by the another viewer object to view the multimedia data), so that the another viewer object may synchronously view the interactive information.

An interface presentation (for example, an interface presentation of the media playback interface), the style, the layout (for example, styles and layouts of various controls), and the like in this embodiment of the present disclosure are examples and do not constitute limitations. Each interface presentation, style, layout, and the like may be designed and presented based on an actual requirement.

In this embodiment of the present disclosure, the computer device may display the media playback interface, the media playback interface being configured for playing the multimedia data; and display the interactive control when the multimedia data played on the media playback interface satisfies the first condition. As can be seen, the computer device may automatically output the interactive control in response to the multimedia data satisfying the first condition, the viewer object does not need to perform a series of cumbersome and complex operations, and the computer device does not need to consume performance resources to respond to the cumbersome and complex operations. This optimizes a response mechanism of the computer device, and reduces a requirement on performance of the computer device. In addition, automatic output of the interactive control effectively simplifies an interactive information posting procedure. Moreover, the outputted interactive control may further prompt and stimulate the viewer object to trigger the interactive control to post interactive information, increasing an interaction frequency. The computer device triggers display of the at least one piece of first interactive information in response to the trigger operation on the interactive control. In this way, interactive information can be conveniently posted by performing a trigger operation on the interactive control, improving convenience of posting interactive information and improving interactivity. The first interactive information may be displayed on the media playback interface in a flowing manner based on the flow trajectory, and the flowing display manner may include moving display, static display, and the like. This can improve the display interestingness of the interactive information and improve the user experience.

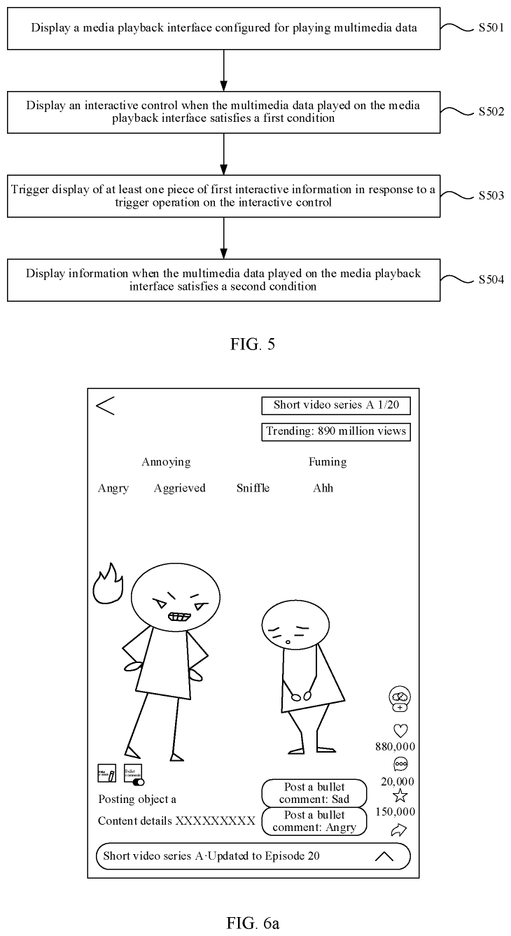

FIG. 5 is a schematic flowchart of another data processing method according to an embodiment of the present disclosure. The data processing method may be performed by a computer device, for example, may be performed by the computer device 102 in the data processing system shown in FIG. 1 alone, or may be performed by the computer device 102 with an assistance of the server 101 in the data processing system shown in FIG. 1. The data processing method may include the following operations S501 to S504.

S501: Display a media playback interface, the media playback interface being configured for playing multimedia data.

S502: Display an interactive control when the multimedia data played on the media playback interface satisfies a first condition.

In one embodiment, that the multimedia data played on the media playback interface satisfies the first condition may include at least one of the following: the multimedia data includes preset media content; the multimedia data is played into a preset playback time; the multimedia data is played to a preset media segment; the multimedia data includes interactive information, and a quantity of pieces of interactive information is greater than a first quantity threshold; the multimedia data includes specific interactive information, and the specific interactive information is interactive information including specific content information or interactive information transmitted by a specific object; and the multimedia data includes the specific interactive information, and a quantity of pieces of specific interactive information is greater than a second quantity threshold. A display duration of the interactive control may be set based on a specific requirement. The related manner for the preset media content and the related manner for the preset playback time have been described in operation S202, and details are not described herein again.

In the related manner for the preset media segment, the preset media segment may be a media segment in streaming media data that satisfies a preset interaction condition. The preset interaction condition may be designed based on a specific requirement, and may be, for example, a plot climax segment or a plot downturn segment in the streaming media data. Quick comment content may be designed as required. The quick comment content included in the interactive control may be adapted to the preset media segment. In some embodiments, the quick comment content adapted to the preset media segment may be comment content that expresses an emotion the same as that expressed by the preset media segment, comment content that expresses a theme the same as that expressed by the preset media segment, or the like.

In the related manner in which the multimedia data includes the interactive information, and the quantity of pieces of interactive information is greater than the first quantity threshold, in one embodiment, the quantity of pieces of interactive information herein may be a quantity of pieces of interactive information of the multimedia data that is being played at a current playback progress, that is, a total quantity of pieces of interactive information posted by all viewer objects of the multimedia data at the current playback progress. A larger quantity of pieces of interactive information indicates higher interaction activity of the viewer objects of the multimedia data at the current playback progress. The first quantity threshold may be set based on a specific requirement. The quick comment content may be designed as required. For example, the quick comment content may be comment content adapted to media content at the current playback progress. For another example, the quick comment content may be an interaction keyword for the current playback progress. The interaction keyword for the current playback progress may be a keyword extracted from the interactive information of the multimedia data at the current playback progress, and may represent an interaction theme of the multimedia data at the current playback progress. In other words, if the multimedia data is played to a specific playback progress, and a quantity of pieces of interactive information correspondingly determined at the playback progress is greater than the first quantity threshold, the computer device determines that the first condition is satisfied, and displays the interactive control.

In the related manner in which the multimedia data includes the specific interactive information, that is, if the multimedia data is played to a playback progress, and the multimedia data includes the specific interactive information at the playback progress, the computer device determines that the first condition is satisfied, and displays the interactive control.

The specific interactive information is the interactive information including the specific content information or the interactive information transmitted by the specific object. The specific content information may be set based on a specific requirement. For example, the specific content information may be set to content information that can be configured for expressing a specific emotion. The specific emotion may be designed as required, and is, for example, joy, sadness, or anger. For example, if the specific emotion is anger, the specific content information may include a text “Angry”, an emoji configured for expressing anger, or the like. For example, interactive information whose content information is “Annoying” is specific interactive information because the content information includes the specific content information “angry”. For another example, the specific content information may be set to content information that may include a specific keyword. The specific keyword may be set based on a specific requirement, and may be, for example, the text “angry” or a text “Dragon Boat Festival”. The specific viewer object may be a viewer object satisfying a specific viewing condition. The specific viewing condition may be designed based on a specific requirement. For example, the specific viewing condition is a viewer object having subscribed to an APP membership of a media playback application, a paying viewer object of the media playback application, or a viewer object having used the media playback application for a cumulative duration exceeding a specific period of time. The quick comment content may be designed as required. For example, the quick comment content may be comment content adapted to the specific interactive information. For example, the comment content adapted to the specific interactive information may include comment content that has semantics the same as that of the specific interactive information, comment content that expresses an emotion the same as that expressed by the specific interactive information, and a keyword of the specific interactive information.

Related manner in which the multimedia data includes the specific interactive information, and the quantity of pieces of specific interactive information is greater than the second quantity threshold

In one embodiment, the quantity of pieces of specific interactive information herein may be a quantity of pieces of specific interactive information contained in a historical playback progress of the multimedia data that is being played up to the current playback progress, that is, a total quantity of pieces of specific interactive information posted by all the viewer objects of the multimedia data in the historical playback progress. In another embodiment, the quantity of pieces of specific interactive information herein may be a quantity of pieces of specific interactive information posted via the computer device in a historical playback progress of the multimedia data that is being played on the computer device up to the current playback progress, that is, a total quantity of pieces of specific interactive information posted by a viewer object using the computer device in the historical playback progress of the multimedia data. In other words, if the multimedia data is played to a specific playback progress, and a quantity of pieces of specific interactive information correspondingly determined at the playback progress is greater than the second quantity threshold, the computer device determines that the first condition is satisfied, and displays the interactive control. The quick comment content may be designed as required. For example, the quick comment content may be comment content adapted to the specific interactive information.

In one embodiment, if a quantity of interactive controls is M, M being an integer greater than 1, a display manner of the M interactive controls may include at least one of the following: displaying the M interactive controls on the media playback interface in parallel; displaying the M interactive controls on the media playback interface in a superimposition manner; or displaying the M interactive controls sequentially on the media playback interface in a random switching manner. This can enhance display interestingness of the interactive control and improve user experience.

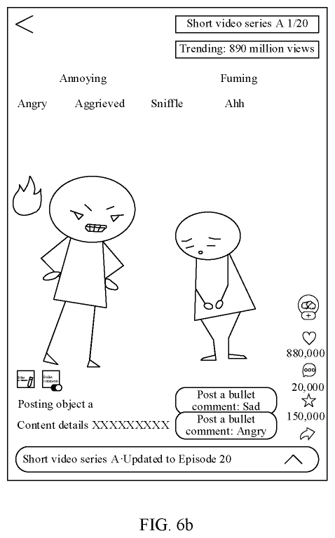

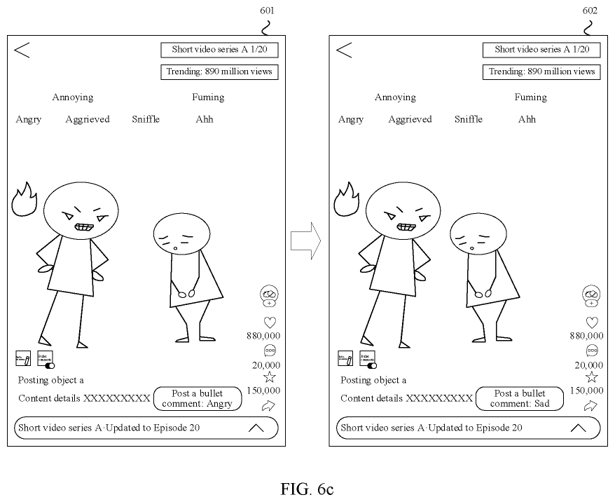

For example, if the multimedia data is a video, when the video is played to video content that expresses anger and sadness, there may be two interactive controls, where one matches anger, and the other matches sadness. FIG. 6a is a schematic diagram of displaying a plurality of interactive controls according to an embodiment of the present disclosure. The M interactive controls are displayed on the media playback interface in parallel. A display location of any interactive control may be designed based on a specific requirement, and is not limited according to various embodiments of the present disclosure. FIG. 6b is another schematic diagram of displaying a plurality of interactive controls according to an embodiment of the present disclosure. The M interactive controls are displayed on the media playback interface in the superimposition manner. A superimposition sequence of the M interactive control during superimposition display may be designed based on a specific requirement, and is not limited according to various embodiments of the present disclosure. FIG. 6c is still another schematic diagram of displaying a plurality of interactive controls according to an embodiment of the present disclosure. The M interactive controls are sequentially displayed on the media playback interface in the random switching manner. Within a playback time period of the video content including anger and sadness, the interactive control matching anger is displayed first in a period of time, and a corresponding media playback interface may be indicated by a reference numeral 601. Then, the interactive control matching sadness is displayed in a remaining time period, and a corresponding media playback interface may be indicated by a reference numeral 602. A display sequence and a display duration of each of the M interactive controls may be set based on a specific requirement, and are not limited according to various embodiments of the present disclosure.

S503: Trigger display of at least one piece of first interactive information in response to a trigger operation on the interactive control.

S504: Display information when the multimedia data played on the media playback interface satisfies a second condition.

In one embodiment, that the multimedia data played on the media playback interface satisfies the second condition may include at least one of the following: the multimedia data includes the first interactive information; the multimedia data includes the first interactive information, and a quantity of pieces of first interactive information reaches a third quantity threshold; the multimedia data includes the specific interactive information, and the specific interactive information is the interactive information including the specific content information or the interactive information transmitted by the specific object; the multimedia data includes the specific interactive information, and the quantity of pieces of specific interactive information reaches a fourth quantity threshold; and an operation duration of the trigger operation performed on the interactive control is greater than a second duration threshold. The third quantity threshold, the fourth quantity threshold, and the second duration threshold may be set as required.

In one embodiment, the quantity of pieces of first interactive information herein may be a quantity of pieces of first interactive information contained in the historical playback progress of the multimedia data that is being played up to the current playback progress, that is, a total quantity of pieces of first interactive information posted by all the viewer objects of the multimedia data in the historical playback progress. In another embodiment, the quantity of pieces of the interactive information herein may be a quantity of pieces of the interactive information posted via the computer device in the historical playback progress of the multimedia data that is being played on the computer device up to the current playback progress, that is, a total quantity of pieces of the first interactive information posted by the viewer object using the computer device in the historical playback progress of the multimedia data. In other words, if the multimedia data is played to a specific playback progress, and a quantity of pieces of first interactive information correspondingly determined at the playback progress reaches the third quantity threshold, the computer device determines that the second condition is satisfied, and displays the information. The quantity of pieces of specific interactive information herein may be the quantity of pieces of specific interactive information contained in the historical playback progress of the multimedia data that is being played up to the current playback progress, that is, the total quantity of pieces of specific interactive information posted by all the viewer objects of the multimedia data in the historical playback progress. In another embodiment, the quantity of pieces of specific interactive information herein may be the quantity of pieces of specific interactive information posted via the computer device in the historical playback progress of the multimedia data that is being played on the computer device up to the current playback progress, that is, the total quantity of pieces of specific interactive information posted by a viewer object using the computer device in the historical playback progress of the multimedia data. In other words, if the multimedia data is played to a specific playback progress, and a quantity of pieces of specific interactive information correspondingly determined at the playback progress reaches the fourth quantity threshold, the computer device determines that the second condition is satisfied, and displays the information. For ease of description, the first interactive information and the specific interactive information may be collectively referred to as target interactive information. In some embodiments, since interactive information posted by the viewer object at a playback progress of the multimedia data via the computer device may be transmitted to a server, after receiving the interactive information, the server may store the interactive information into a bullet comment pool. Based on this, the quantity of pieces of first interactive information and the quantity of pieces of specific interactive information may be determined by counting first interactive information in the bullet comment pool and counting specific interactive information in the bullet comment pool.

In one embodiment, the information may be displayed on the media playback interface in a bullet comment form. The information displayed on the media playback interface in the bullet comment form is to be restricted by a flow trajectory, and the information may be displayed on the media playback interface in a flowing manner based on the flow trajectory corresponding to the information. The flowing display manner may include moving display, static display, and the like. This can improve display interestingness of the information and improve the user experience. The flowing display manner may be designed as required. A related process of displaying the information on the media playback interface in the bullet comment form is similar to a related process of displaying the interactive information on the media playback interface in a bullet comment form.

In one embodiment, a display manner of the information may include at least one of the following: displaying the information in a flowing manner based on a flow trajectory the same as that of the interactive information if the interactive information is displayed in a flowing manner; displaying the information in a flowing manner based on a flow trajectory different from that of the interactive information; or displaying the information statically or dynamically at any location on the media playback interface at which no interactive information is blocked. The information may be pushed to a plurality of viewer objects of the multimedia data. Alternatively, the information may be pushed to a viewer object in a plurality of viewer objects that has transmitted interactive information. Alternatively, the information may be pushed to a viewer object in a plurality of viewer objects that has transmitted target interactive information. Pushing content such as the multimedia data and the information to a viewer object is specifically pushing the content to a computer device used by the viewer object to view the multimedia data.

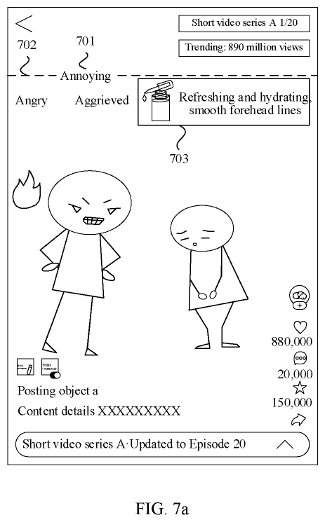

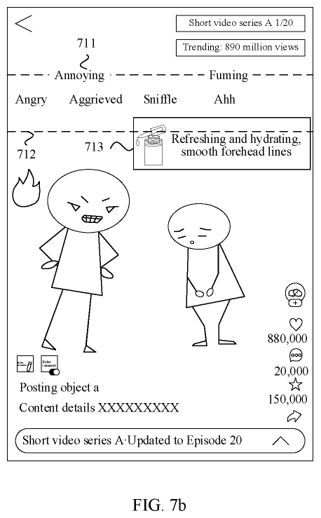

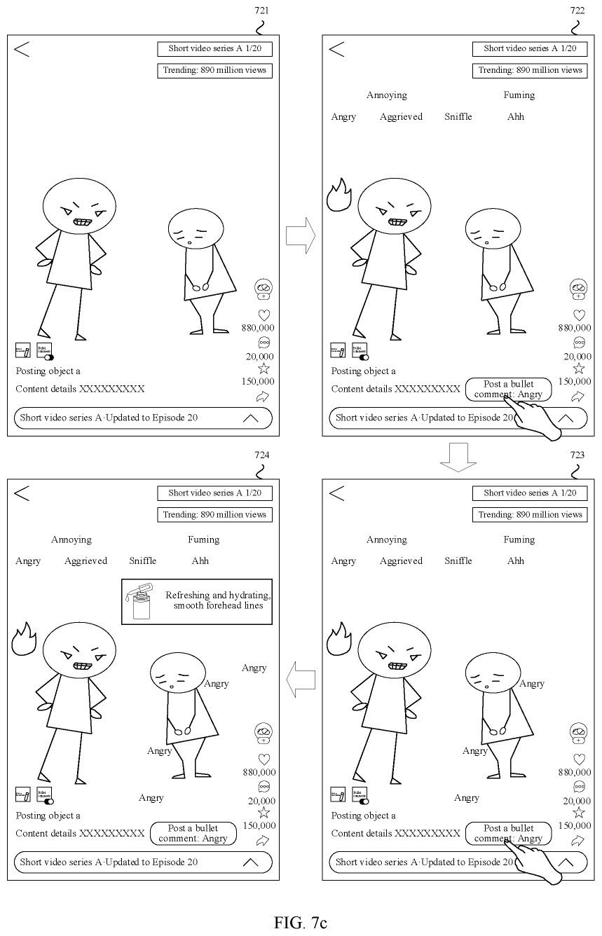

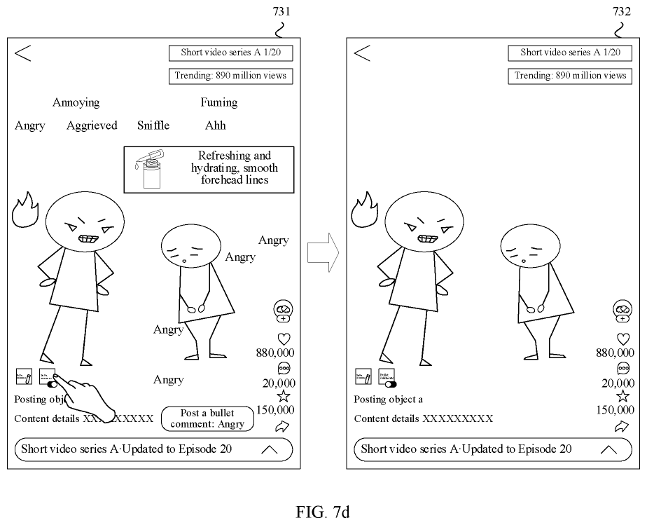

In one embodiment, the computer device displays the information in a flowing manner based on the flow trajectory the same as that of the interactive information. The flow trajectory the same as that of the interactive information may be a flow trajectory the same as that of any piece of target interactive information. Alternatively, the flow trajectory the same as that of the interactive information may be a flow trajectory the same as that of any piece of interactive information. The flow trajectory the same as that of the interactive information may be selected in a random selection manner, or may be selected according to a specific selection rule. The selection rule may be set based on a specific requirement, and is not limited according to various embodiments of the present disclosure. If content information of the target interactive information is a text, and the text is “Annoying”, the information displayed on the media playback interface may be information whose copy content is a text and an image, where the text is “Refreshing and hydrating, smooth forehead lines”, and the image is an advertising image of a skincare product X. FIG. 7a is a schematic diagram of displaying information according to an embodiment of the present disclosure. The computer device displays the information on the media playback interface in a flowing manner based on the flow trajectory the same as that of the interactive information. Specifically, the computer device displays the information on the media playback interface in a flowing manner based on the flow trajectory the same as that of the target interactive information. The target interactive information may be indicated by a reference numeral 701, the flow trajectory the same as that of the target interactive information may be indicated by a reference numeral 702, and the information may be indicated by a reference numeral 703. A style of the information indicated by the reference numeral 703 is different from that of the target interactive information.

In one embodiment, the computer device displays the information in a flowing manner based on the flow trajectory different from that of the interactive information. The flow trajectory different from that of the interactive information may be a flow trajectory different from each piece of interactive information. The media playback application may provide at least one flow trajectory configured for displaying the information (for ease of description, the flow trajectory is referred to as an information flow trajectory, and the information flow trajectory is not configured for displaying the interactive information in a flowing manner). Based on this, when determining the information, the computer device may select one information flow trajectory to display the information. In some embodiments, an information flow trajectory may be randomly selected, or may be selected according to a specific selection rule. The selection rule may be set based on a specific requirement, and is not limited according to various embodiments of the present disclosure. In some embodiments, a trajectory shape, a trajectory size, a trajectory location, and the like of the information flow trajectory may be configured as required. If content information of the target interactive information is a text, and the text is “Annoying”, the information displayed on the media playback interface may be information whose copy content is a text and an image, where the text is “Refreshing and hydrating, smooth forehead lines”, and the image is an advertising image of a skincare product X. FIG. 7b is another schematic diagram of displaying information according to an embodiment of the present disclosure. The computer device displays the information on the media playback interface in a flowing manner based on the flow trajectory different from that of the interactive information. The target interactive information may be indicated by a reference numeral 711, the flow trajectory corresponding to the information may be indicated by a reference numeral 712, and the information may be indicated by a reference numeral 713. A style of the information indicated by the reference numeral 713 is different from that of the target interactive information.

In one embodiment, the computer device may display the information statically or dynamically at any location on the media playback interface at which no interactive information is blocked. In some embodiments, when the computer device displays the information statically, within a display duration of the information, the information may be displayed statically at a location on the media playback interface at which no interactive information is blocked; or when the computer device displays the information dynamically, within a display duration of the information, the information may be displayed dynamically at different locations on the media playback interface at which no interactive information is blocked. For example, the display duration of the information is divided into two time periods, where the information is displayed at a location in the first time period, and the information is displayed at another location in the second time period. For another example, the display duration of the information is divided into three time periods, where one time period corresponds to one location for displaying the information. In one embodiment, when the computer device displays the information statically at any location on the media playback interface at which no interactive information is blocked, the information may be displayed statically based on the flow trajectory. When the computer device displays the information dynamically at any location on the media playback interface at which no interactive information is blocked, the information may be displayed dynamically based on a plurality of flow trajectories. For example, the display duration of the information is divided into two time periods, where the information is displayed statically at a location based on one flow trajectory in the first time period, and the information is displayed statically at another location based on another flow trajectory in the second time period.

In one embodiment, the information may be determined based on the target interactive information, and the target interactive information includes the first interactive information and the specific interactive information. A determining manner of the information may be: determining, from a plurality of pieces of to-be-pushed copy content based on the target interactive information, copy content matching the target interactive information, and constructing the information based on the determined copy content, that the copy content matches the target interactive information including at least one of the following: semantics of the copy content matches semantics of content information of the target interactive information; the copy content and the content information of the target interactive information have matching keywords; an emotion expressed by the copy content matches an emotion expressed by the target interactive information; and an item associated with the copy content matches the emotion expressed by the target interactive information. In other words, that the information matches the target interactive information is specifically that copy content of the information matches the target interactive information. The copy content may include but is not limited to one or more of the following: a text, an emoji, an image, and audio. For example, if the content information of the target interactive information is a text, and the text is “Eat dumplings during the Spring Festival”, the information may be information whose copy content is a text, and the text is “Happy new year! Enjoy dumplings of Brand Z”. If the content information of the target interactive information is a text, and the text is “He plays basketball really well”, the information may be information whose copy content is a text, and the text is “Play better basketball? Choose Brand Y”. If the content information of the target interactive information is a text, and the text is “Annoying”, the information may be information whose copy content is a text and an image, where the text is “Refreshing and hydrating, smooth forehead lines”, and the image is an advertising image of a skincare product X.

That the semantics of the copy content matches the semantics of the content information of the target interactive information may include instances where the copy content and the content information of the target interactive information have same or similar semantics, and the like. In one embodiment, a semantic feature of the copy content and a semantic feature of the content information may be separately extracted, a feature similarity between the semantic feature of the copy content and the semantic feature of the content information is calculated, and whether the semantics of the copy content and the semantics of the content information match each other or a matching degree may be determined based on the feature similarity. For example, when the feature similarity is greater than a similarity threshold, it is determined that the semantics of the copy content and the semantics of the content information match each other. The similarity threshold may be set based on a specific requirement. The semantic feature may be implemented by using a feature extraction technology such as a neural network model. This is not limited according to various embodiments of the present disclosure. That the copy content and the content information of the target interactive information have the matching keywords may include instances where the copy content has a keyword the same as or similar to a keyword of the content information of the target interactive information. The similar keyword may include a synonym, a near-synonym, and the like. In one embodiment, the keyword is extracted from the content information, and keyword matching is performed based on the keyword of the content information and the copy content, to further determine whether the content information matches the copy content or the matching degree.

That the emotion expressed by the copy content matches the emotion expressed by the target interactive information may include instances where the emotion expressed by the copy content is the same as the emotion expressed by the target interactive information. For example, if both the copy content and the content information of the target interactive information express joy, it may be determined that the emotions match. That the item associated with the copy content matches the emotion expressed by the target interactive information may include instances where an emotion preconfigured for the item associated with the copy content is the same as the emotion expressed by the target interactive information. For example, in an advertisement scenario, a to-be-advertised item includes a paper towel and a skincare product, an emotion preconfigured for the paper towel is sadness, and an emotion preconfigured for the skincare product is anger, that is, information corresponding to the paper towel (that is, advertisement information configured for promoting the paper towel) is pushed when the viewer object feels sad, and information corresponding to the skincare product (that is, advertisement information configured for promoting the skincare product) is pushed when the viewer object feels angry. In this case, if the emotion expressed by the target interactive information is sadness, information of an item matching the emotion expressed by the target interactive information is pushed, that is, the information corresponding to the paper towel is pushed. If the emotion expressed by the target interactive information is anger, information of an item matching the emotion expressed by the target interactive information is pushed, that is, the information corresponding to the skincare product is pushed. In some embodiments, this embodiment of the present disclosure further supports preconfiguration of a matching relationship between content information and copy content, configuration of a matching relationship between content information and an item, configuration of a matching relationship between a keyword and copy content, configuration of a matching relationship between a keyword and an item, and the like as required, so that the copy content matching the target interactive information may be determined by querying the matching relationships.

In one embodiment, in a process of constructing the information based on the determined copy content, a style of the information may be determined from a plurality of preset styles, and the information may be constructed based on the determined copy content and style. In one embodiment, the style of the information may be randomly determined from the plurality of preset styles. In one embodiment, the style of the information may be determined from the plurality of preset styles based on a quantity of pieces of target interactive information and a mapping relationship between a quantity interval and a preset style. For example, the mapping relationship between the quantity interval and the preset style indicates that a first quantity interval corresponds to a first style, a second quantity interval corresponds to a second style, and a third quantity interval corresponds to a third style, where a minimum quantity value of the third quantity interval is greater than a maximum quantity value of the second quantity interval, and a minimum quantity value of the second quantity interval is greater than a maximum quantity value of the first quantity interval. In this case, when the quantity of pieces of target interactive information is within the first quantity interval, the style of the information is the first style; or when the quantity of pieces of target interactive information is within the second quantity interval, the style of the information is the second style. The preset style, the mapping relationship between the quantity interval and the preset style, and the like may be set as required, and are not limited according to various embodiments of the present disclosure.

As can be seen from the foregoing descriptions, according to this embodiment of the present disclosure, the information matching the target interactive information may be pushed based on the target interactive information interactively posted by the viewer object of the multimedia data in the process of viewing the multimedia data. This can adapt pushing of the information to user interaction, implement personalized and precise pushing of information based on an interaction situation of a user, and improve an information pushing effect. For example, personalized and precise pushing of the information can be implemented by matching an emotion of the user, and different information is pushed under different emotions of the user.

In one embodiment, the information may be determined based on the target interactive information, and the target interactive information includes the first interactive information or specific interactive information. A determining manner of the information may be: determining media content played by the multimedia data when the multimedia data played on the media playback interface satisfies the second condition; and determining, from a plurality of pieces of to-be-pushed copy content based on the media content played by the multimedia data, copy content matching the media content played by the multimedia data, and constructing the information based on the determined copy content, that the copy content matches the media content played by the multimedia data including at least one of the following: an emotion expressed by the copy content matches an emotion expressed by the media content played on the multimedia data; and an item associated with the copy content matches the emotion expressed by the media content played on the multimedia data. A related process of constructing the information based on the determined copy content has been described above, and details are not described herein again. That the emotion expressed by the copy content matches the emotion expressed by the media content played by the multimedia data may include instances where the emotion expressed by the copy content is the same as the emotion expressed by the media content played by the multimedia data. For example, if both the copy content and the media content played by the multimedia data express sadness, it may be determined that the emotions match. That the item associated with the copy content matches the emotion expressed by the media content played by the multimedia data may include instances where an emotion preconfigured for the item associated with the copy content is the same as the emotion expressed by the media content played by the multimedia data.

FIG. 7c is a schematic diagram of triggering display of information according to an embodiment of the present disclosure. Correspondingly, the second condition is satisfied when the multimedia data includes the first interactive information and the quantity of pieces of first interactive information reaches the third quantity threshold. The computer device may display the media playback interface configured for playing the multimedia data, where the media playback interface on which the multimedia data is played may be indicated by a reference numeral 721; display the interactive control when the multimedia data played on the media playback interface satisfies the first condition, where a media playback interface displaying the interactive control may be indicated by a reference numeral 722; trigger display of the at least one piece of first interactive information in response to the trigger operation on the interactive control, where a media playback interface displaying the first interactive information may be indicated by a reference numeral 723; and display the information when the multimedia data played on the media playback interface satisfies the second condition, where a media playback interface displaying the information may be indicated by a reference numeral 724.

In one embodiment, the computer device may further stop, in response to a bullet comment turn-off operation, displaying the interactive information and the information. Descriptions related to the bullet comment turn-off operation are described in the foregoing embodiment, and details are not described herein again. As can be seen from this, in this manner, the information can be quickly closed, improving the user experience. FIG. 7d is a schematic diagram of closing information according to an embodiment of the present disclosure. A media playback interface displayed before the information is closed may be indicated by a reference numeral 731, and displays the first interactive information and the information. A media playback interface displayed after the information is closed may be indicated by a reference numeral 732.

In one embodiment, the information may be determined based on the target interactive information, and the target interactive information includes the first interactive information or the specific interactive information. The computer device may further adjust the displayed information dynamically when the quantity of pieces of target interactive information changes, adjust the displayed information dynamically when the operation duration of the trigger operation performed on the interactive control increases, and adjust the displayed information dynamically when a first feedback operation for the information is detected, the dynamic adjustment including at least one of the following: displaying new information instead, adjusting the copy content of the displayed information, adjusting the style of the displayed information, adjusting a display location of the displayed information, and adjusting the display manner of the displayed information.

In some embodiments, the manner of adjusting the information dynamically based on the change in the quantity of pieces of target interactive information may be set as required. For example, when the quantity of pieces of target interactive information changes from the first quantity interval to the second quantity interval, the style of the information is adjusted from the first style to the second style; and when the quantity of pieces of target interactive information changes from the second quantity interval to the third quantity interval, the style of the information is adjusted from the second style to the third style. For another example, when the quantity of pieces of target interactive information changes from the second quantity interval to the third quantity interval, the display manner of the information is adjusted from a static display manner based on a flow trajectory to a moving display manner based on a flow trajectory. Adjusting the displayed information dynamically based on the change in the quantity of pieces of target interactive information enhances interestingness in pushing the information, helps expand coverage for pushing the information, and can improve the user experience. In some embodiments, the manner of adjusting the information dynamically based on an increase in the operation duration of the trigger operation performed on the interactive control may be set as required.

In some embodiments, the first feedback operation configured for triggering a dynamic adjustment to the information may be set as required, and a dynamic adjustment manner may also be set as required. For example, in one embodiment, when the first feedback operation for the information is detected, and the first feedback operation requests to reduce a display size of the information, the computer device may adjust the display size in the style of the displayed information, to reduce the display size of the information. For another example, in one embodiment, when the first feedback operation for the information is detected, and the first feedback operation is an operation of transmitting interactive information to the information (for example, an effect of transmitting the interactive information to the information may be achieved by triggering the information to enter a bullet comment input region and inputting the interactive information in the bullet comment input region), the computer device may display the new information instead, the new information and the transmitted interactive information matching each other. For another example, in one embodiment, when the first feedback operation for the information is detected, and the first feedback operation is a like operation, the computer device may adjust the copy content of the displayed information, to implement deep pushing to the viewer object. The information displayed on the media playback interface may be adjusted dynamically based on feedback from the viewer object for the information. This enhances the interestingness in pushing the information, helps expand the coverage for pushing the information, and can improve the user experience.

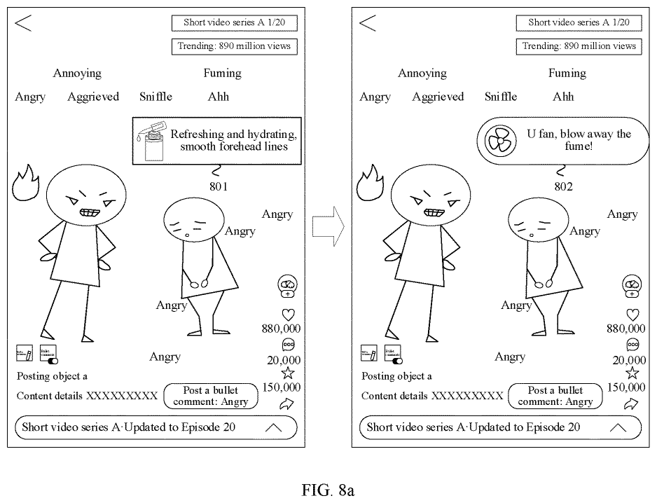

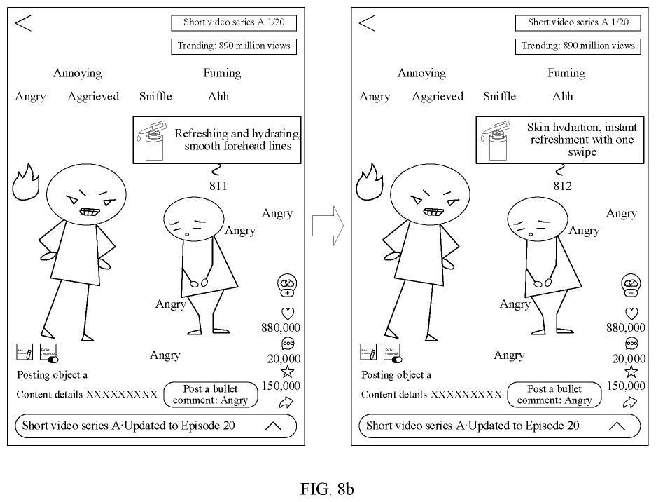

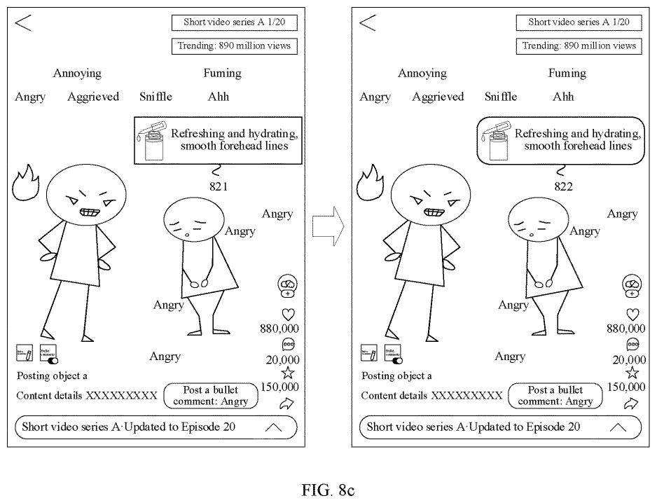

FIG. 8a is a schematic diagram of dynamically adjusting displayed information according to an embodiment of the present disclosure. This dynamic adjustment may include displaying the information instead. The information displayed before the dynamic adjustment may be indicated by a reference numeral 801, and information displayed after the dynamic adjustment may be indicated by a reference numeral 802. FIG. 8b is another schematic diagram of dynamically adjusting displayed information according to an embodiment of the present disclosure. This dynamic adjustment may include adjusting the copy content of the displayed information. The information displayed before the dynamic adjustment may be indicated by a reference numeral 811, and information displayed after the dynamic adjustment may be indicated by a reference numeral 812. FIG. 8 c is still another schematic diagram of dynamically adjusting displayed information according to an embodiment of the present disclosure. This dynamic adjustment may include adjusting the style of the displayed information. The information displayed before the dynamic adjustment may be indicated by a reference numeral 821, and information displayed after the dynamic adjustment may be indicated by a reference numeral 822.

In one embodiment, the computer device may further display an associated page of the information in response to an interactive operation on the information, the information including at least one of the following: advertisement information, game information, and guessing information; the associated page being an advertisement detail page when the information is the advertisement information; the associated page being a game entry page, a game trial page, or a game result page when the information is the game information; and the associated page being a guessing result page when the information is the guessing information. The interactive operation and the associated page displayed in response to the interactive operation may both be designed based on a specific requirement.

In one embodiment, when the information is the advertisement information, the associated page may be the advertisement detail page, and the interactive operation may be a trigger operation such as a tap operation or a pressing operation. In other words, after detecting the trigger operation on the advertisement information, the computer device may jump to the advertisement detail page. This function may be implemented by embedding a page link to the advertisement detail page into the advertisement information. In some embodiments, the advertisement detail page may support purchasing of a product corresponding to the advertisement information, to improve a conversion effect of the advertisement information.

In one embodiment, the game information may include first game information configured for promoting a game and second game information configured for supporting a user in participating in the game on the media playback interface. When the information is the first game information, the associated page may be the game entry page, the game trial page, or the like, and the interactive operation may be a trigger operation such as a tap operation or a pressing operation. In other words, after detecting the trigger operation on the first game information, the computer device may jump to the game entry page, the game trial page, or the like. When the information is second game information, the associated page may be the game result page. For example, the second game information may be configured for implementing a question-answering game. The second game information includes a question and a result option, and supports the viewer object in selecting the result option. The interactive operation may include a selection operation on the result option. The computer device may display, based on the selection operation of the viewer object on the result option, the game result page indicating that a result is correct or incorrect. In some embodiments, incentive mechanisms corresponding to different game results may be set as required, to incentivize corresponding viewer objects, improving the user experience.

In one embodiment, when the information is the guessing information, the associated page is the guessing result page. For example, the guessing information may include a question and a result option, and supports the viewer object in selecting the result option. The interactive operation may include a selection operation on the result option. The computer device may display, based on the selection operation of the viewer object on the result option, the guessing result page indicating that a result is correct or incorrect. For example, the guessing information may include a question and a result input component, and supports the viewer object in inputting an answer to a corresponding question by triggering the result input component. The interactive operation may include an operation related to answer submission. The computer device may display, based on the answer submitted by the viewer object, the guessing result page indicating that a result is correct or incorrect. In some embodiments, incentive mechanisms corresponding to different game results may be set as required, to incentivize corresponding viewer objects, improving the user experience.

In one embodiment, the computer device may further receive a second feedback operation on the interactive information included in the multimedia data, calculate a popularity of each piece of interactive information based on a second feedback operation performed on each piece of interactive information, and perform, based on the popularity of each piece of interactive information, incentive processing on a viewer object transmitting the corresponding interactive information. The second feedback operation may include a positive feedback operation and a negative feedback operation. The positive feedback operation on the interactive information may increase the popularity of the corresponding interactive information, and the negative feedback operation on the interactive information may reduce the popularity of the corresponding interactive information. For example, a positive feedback operation on a piece of interactive information may include a like operation on the interactive information, and an operation of copying and posting the interactive information. A negative feedback operation on a piece of interactive information may include a dislike operation on the interactive information, a report operation on the interactive information, a hide operation on the interactive information, a related operation of marking all interactive information of a viewer object transmitting the interactive information as blocked, and the like.

In some embodiments, when a popularity of a piece of interactive information is calculated based on a second feedback operation performed on the interactive information, a popularity calculation rule may be set as required. For example, the popularity calculation rule may be: different positive feedback operations correspondingly increase different popularity values, and different negative feedback operations correspondingly reduce different popularity values, so that the popularity of the interactive information may be obtained through summation based on a quantity of various second feedback operations performed on the interactive information and popularity values corresponding to the second feedback operations. For another example, the popularity calculation rule may further include setting corresponding weights for different second feedback operations, so that the popularity of the interactive information is obtained through weighted summation based on a quantity of various second feedback operations performed on the interactive information and corresponding popularity values and weights. When incentive processing is performed, based on the popularity of each piece of interactive information, on the viewer object transmitting the corresponding interactive information, an incentive rule may be set as required to perform incentive processing. For example, incentive processing is performed when the popularity reaches a popularity threshold, incentive processing is not performed when the popularity does not reach the popularity threshold, and a higher popularity indicates more incentives. The popularity threshold may be set based on a specific requirement. Incentivizing the viewer object posting the interactive information can invoke enthusiasm of the incentivized viewer object for transmitting interactive information, improving enthusiasm of the incentivized viewer object for posting more target interactive information. This can increase a possibility of information exposure.

A related procedure of the foregoing data processing method may be performed by the computer device alone, or may be performed by the computer device with the assistance of the server. The following describes details of a related process in which the data processing method provided in the embodiments of the present disclosure is performed by the computer device with the assistance of the server.

In one embodiment, interactive information posted by a viewer object at a playback progress of the multimedia data via a computer device may be transmitted to the server. After receiving the interactive information, the server may store the interactive information into the bullet comment pool, and may further push the interactive information to another viewer object (that is, transmit the interactive information to a computer device used by the another viewer object to view the multimedia data), so that the another viewer object may synchronously view the interactive information.

In one embodiment, a related process of determining whether the multimedia data played on the media playback interface satisfies the second condition may be performed by the computer device, or may be performed by the server. When this related process is performed by the server, after determining that the multimedia data satisfies the second condition, the server may deliver the information to the computer device, so that the computer device may display the information. In one embodiment, any piece of interactive information posted by the viewer object via the computer device may be transmitted to the server. After receiving the interactive information, the server may store the interactive information into the bullet comment pool. If the interactive information is target interactive information, the server may determine, based on the target interactive information, whether the second condition is satisfied, determine, after determining that the second condition is satisfied, information that needs to be delivered to the computer device, and deliver the information to the computer device.

In one embodiment, when the quantity of pieces of target interactive information changes, the dynamic adjustment to the displayed information may be performed by the computer device alone. Alternatively, when the quantity of pieces of target interactive information changes, the server determines adjusted content, and delivers the adjusted content to the computer device, so that the computer device may adjust the displayed information dynamically based on the adjusted content.

In one embodiment, when the operation duration of the trigger operation performed on the interactive control increases, or when the first feedback operation for the information is detected, the dynamic adjustment to the displayed information may be performed by the computer device alone. Alternatively, when the operation duration of the trigger operation performed on the interactive control increases, or when the first feedback operation for the information is detected, the computer device transmits corresponding feedback information to the server, and the server determines adjusted content, and delivers the adjusted content to the computer device, so that the computer device may adjust, dynamically based on the adjusted content, the information displayed on the media playback interface.

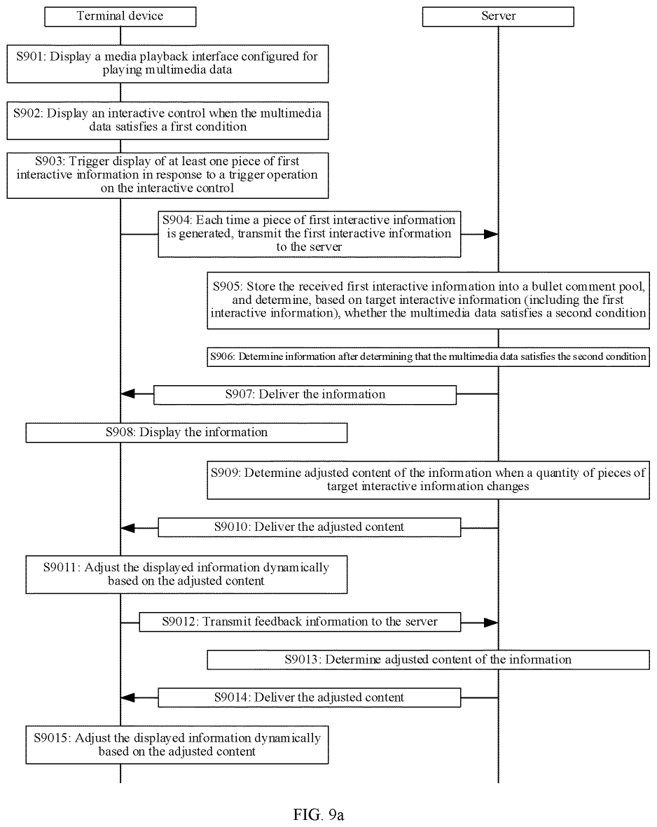

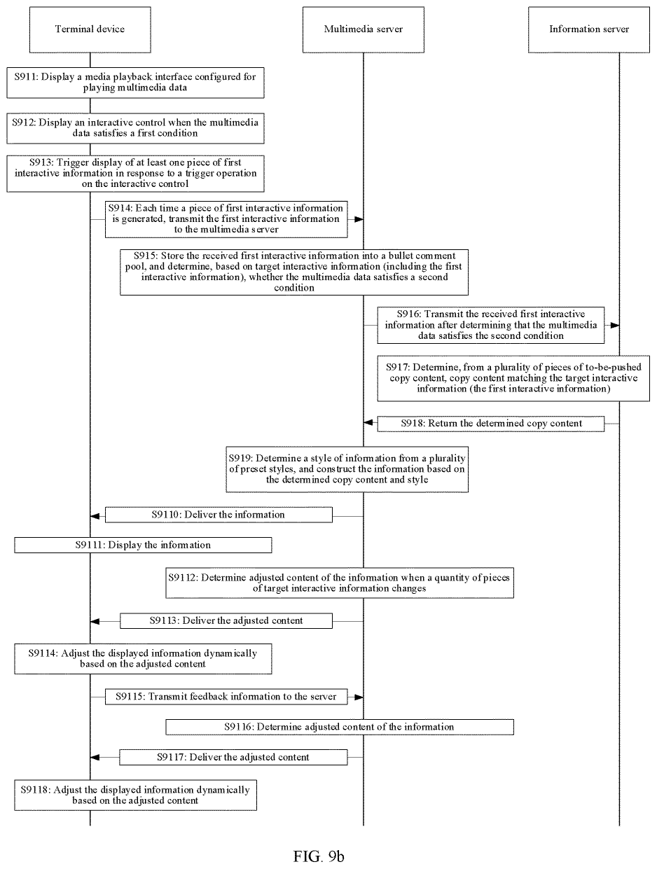

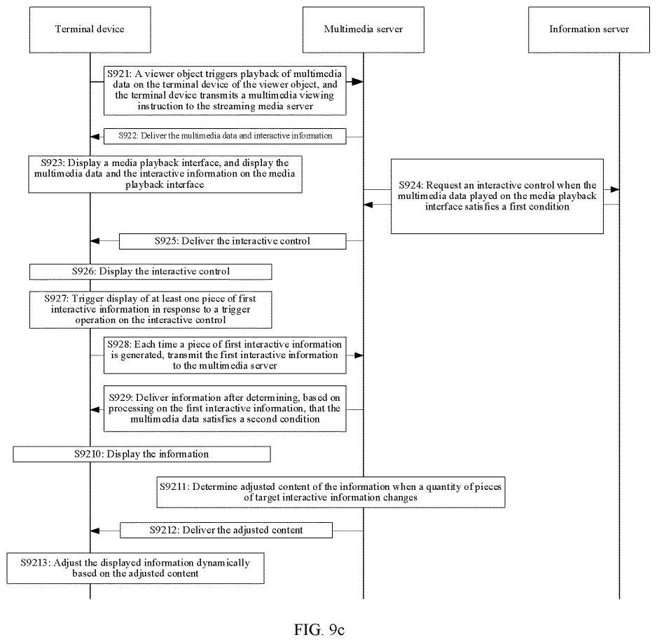

In one embodiment, FIG. 9a is a schematic diagram of performing a data processing method according to an embodiment of the present disclosure. When the data processing method is performed, the following operations may be included.

S901: The computer device displays a media playback interface configured for playing multimedia data. S902: The computer device displays an interactive control when the multimedia data played on the media playback interface satisfies a first condition. S903: The computer device triggers display of at least one piece of first interactive information in response to a trigger operation on the interactive control. S904: The computer device transmits, each time first interactive information is triggered by using the interactive control, the first interactive information to the server (that is, each time a piece of first interactive information is generated, the first interactive information is displayed on the computer device and transmitted to the server). S905: The server stores the received first interactive information into a bullet comment pool, and determines, based on target interactive information (including the first interactive information), whether the multimedia data satisfies a second condition. S906: The server determines, after determining that the multimedia data satisfies the second condition, information that needs to be delivered to the computer device. S907: The server delivers the information to the computer device. S908: The computer device displays the information.

S909: The server may determine adjusted content of the information when a quantity of pieces of target interactive information changes. S9010: The server delivers the adjusted content to the computer device. S9011: The computer device may adjust the displayed information dynamically based on the adjusted content. S9012: The computer device may transmit feedback information to the server when an operation duration of the trigger operation performed on the interactive control increases or when a first feedback operation for the information is detected. S9013: The server may determine adjusted content of the information. S9014: The server delivers the adjusted content to the computer device. S9015: The computer device may adjust the displayed information dynamically based on the adjusted content.

In one embodiment, the server may include a multimedia server and an information server. The multimedia server may be configured to process related processes of multimedia data delivery, interactive information delivery, and information delivery. The information server may be configured to process a related process of determining the information that needs to be pushed to the computer device.

FIG. 9b is a schematic diagram of performing another data processing method according to an embodiment of the present disclosure. When the data processing method is performed, the following operations may be included.

S911: The computer device displays a media playback interface configured for playing multimedia data. S912: The computer device displays an interactive control when the multimedia data played on the media playback interface satisfies a first condition. S913: The computer device triggers display of at least one piece of first interactive information in response to a trigger operation on the interactive control. S914: The computer device transmits, each time first interactive information is triggered by using the interactive control, the first interactive information to the multimedia server (that is, each time a piece of first interactive information is generated, the first interactive information is displayed on the computer device and transmitted to the multimedia server). S915: The multimedia server stores the received first interactive information into a bullet comment pool, and determines, based on target interactive information (including the first interactive information), whether the multimedia data satisfies a second condition. S916: The multimedia server may transmit the received first interactive information to the information server after determining that the multimedia data satisfies the second condition. S917: The information server may determine, from a plurality of pieces of to-be-pushed copy content, copy content matching the target interactive information (the first interactive information). S918: The information server may return the determined copy content to the multimedia server. S919: The multimedia server may determine a style of information from a plurality of preset styles, and construct the information based on the determined copy content and style. S9110: The multimedia server delivers the information to the computer device. S9111: The computer device displays the information.

S9112: The server may determine adjusted content of the information when a quantity of pieces of target interactive information changes. S9113: The server delivers the adjusted content to the computer device. S9114: The computer device may adjust the displayed information dynamically based on the adjusted content. S9115: The computer device may transmit feedback information to the server when an operation duration of the trigger operation performed on the interactive control increases or when a first feedback operation for the information is detected. S9116: The server may determine adjusted content of the information. S9117: The server delivers the adjusted content to the computer device. S9118: The computer device may adjust the displayed information dynamically based on the adjusted content.

In another embodiment, the interactive control that needs to be displayed on the media playback interface may alternatively be delivered by the server to the computer device. For example, when the server includes a multimedia server and an information server, the interactive control may be determined by the information server and delivered by the multimedia server to the computer device.

FIG. 9c is a schematic diagram of performing still another data processing method according to an embodiment of the present disclosure. When the data processing method is performed, the following operations may be included. S921: A viewer object triggers playback of multimedia data on a computer device of the viewer object, and the computer device transmits a multimedia viewing instruction to the multimedia server, to request to deliver the multimedia data. S922: The multimedia server delivers the multimedia data and interactive information to the computer device. S923: The computer device may display a media playback interface, and display the multimedia data and the interactive information on the media playback interface. S924: The multimedia server may request the information server for an interactive control when the multimedia data played on the media playback interface satisfies a first condition. S925: The multimedia server delivers the interactive control to the computer device. S926: The computer device displays the interactive control. S927: The computer device triggers display of at least one piece of first interactive information in response to a trigger operation on the interactive control. S928: The computer device transmits, each time first interactive information is triggered by using the interactive control, the first interactive information to the multimedia server (that is, each time a piece of first interactive information is generated, the first interactive information is displayed on the computer device and transmitted to the multimedia server). S929: The multimedia server delivers information to the computer device after determining, based on processing on the first interactive information, that the multimedia data satisfies a second condition. S9210: The computer device displays the information. S9211: The server may determine adjusted content of the information when a quantity of pieces of target interactive information changes. S9212: The server delivers the adjusted content to the computer device. S9213: The computer device may adjust the displayed information dynamically based on the adjusted content. The computer device may transmit feedback information to the server when an operation duration of the trigger operation performed on the interactive control increases or when a first feedback operation for the information is detected. The server may determine the adjusted content of the information. The server delivers the adjusted content to the computer device. The computer device may adjust the displayed information dynamically based on the adjusted content.

In this embodiment of the present disclosure, the media playback interface configured for playing the multimedia data is displayed, the interactive control is displayed when the multimedia data played on the media playback interface satisfies the first condition, and display of the at least one piece of first interactive information is triggered in response to the trigger operation on the interactive control. In other words, interactive information may be conveniently posted based on the interactive control displayed when the multimedia data played on the media playback interface satisfies the first condition. This can improve convenience of posting interactive information, improve convenience of user interaction, and further improve the user experience. In addition, the information may be displayed when the multimedia data played on the media playback interface satisfies the second condition. The information may be displayed on the media playback interface in a flowing manner based on the flow trajectory. The flowing display manner may include moving display, static display, and the like. This can improve the display interestingness of the information, and improve the user experience. In addition, for information pushing, the information matching the target interactive information may be pushed based on the target interactive information interactively posted in a processing in which the viewer object of the multimedia data views the multimedia data. This can adapt pushing of the information to user interaction, implement personalized and precise pushing of information based on an interaction situation of a user, and improve an information pushing effect. For example, personalized and precise pushing of the information can be implemented by matching an emotion of the user, and different information is pushed under different emotions of the user. Moreover, the information displayed on the media playback interface may be adjusted dynamically based on a change in the quantity of pieces of target interactive information and feedback from the viewer object for the information. This enhances the interestingness pushing the information, helps expand the coverage for pushing the information, and can improve the user experience.

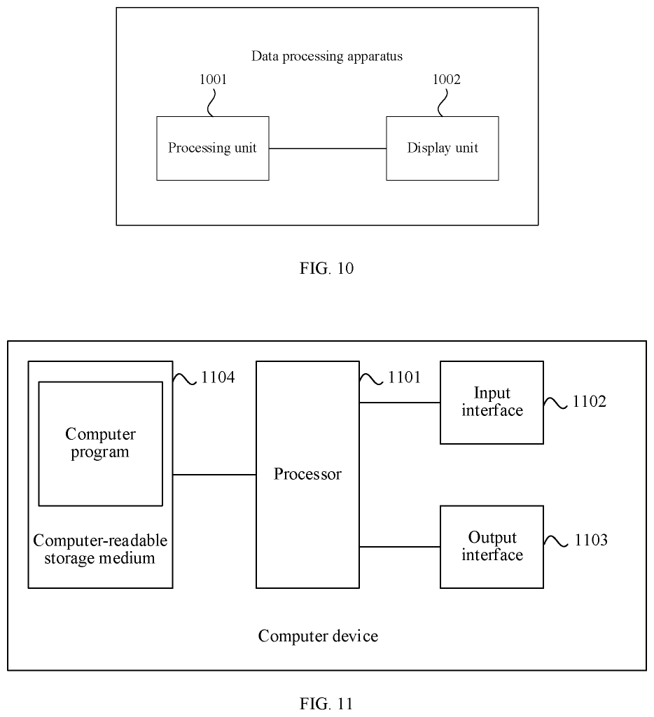

Based on the descriptions of the foregoing method embodiment, an embodiment of the present disclosure further discloses a data processing apparatus. The data processing apparatus may be a computer program run on a computer device. The data processing apparatus may perform the operations in the method procedure shown in FIG. 2 or FIG. 5. FIG. 10 is a schematic diagram of a structure of a data processing apparatus according to an embodiment of the present disclosure. The data processing apparatus may include a processing unit 1001 and a display unit 1002. The display unit 1001 is configured to display a media playback interface configured for playing multimedia data. The processing unit 1002 is configured to display an interactive control when the multimedia data played on the media playback interface satisfies a first condition. The processing unit 1002 is further configured to trigger display of at least one piece of first interactive information in response to a trigger operation on the interactive control.

According to another embodiment of the present disclosure, the units of the data processing apparatus shown in FIG. 10 may be separately or all combined into one or more other units, or a specific unit (or some specific units) of the data processing apparatus may be further split into a plurality of units with more detailed functions. This can implement a same operation without affecting implementation of the technical effects of this embodiment of the present disclosure. The foregoing units are obtained through division based on logical functions. In an actual application, a function of one unit may be implemented by a plurality of units, or functions of a plurality of units may be implemented by one unit. In another embodiment of the present disclosure, the data processing apparatus may further include other units. In an actual application, these functions may be implemented collaboratively by the other units, and may be implemented collaboratively by a plurality of units.

According to another embodiment of the present disclosure, a computer program capable of performing each operation in the corresponding method shown in FIG. 2 or FIG. 5 may be run on a general-purpose computing device, for example, a computer, including a processing element and a storage element, for example, a central processing unit (CPU), a random access memory (RAM), and a read-only memory (ROM), to structure the data processing apparatus shown in FIG. 10 and implement the data processing method in the embodiments of the present disclosure. The computer program may be recorded in, for example, a computer-readable storage medium, loaded on the computer device by using the computer-readable storage medium, and run on the computer device.

In the embodiments of the present disclosure, the term “module” or “unit” is a computer program with a preset function or a part of a computer program and works, together with other related parts, to implement a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an overall module or unit including the module or unit function.

In this embodiment of the present disclosure, a media playback interface configured for playing multimedia data is displayed, an interactive control is displayed when the multimedia data played on the media playback interface satisfies a first condition, and display of at least one piece of first interactive information is triggered in response to a trigger operation on the interactive control. In other words, interactive information may be conveniently posted based on the interactive control displayed when the multimedia data played on the media playback interface satisfies the first condition. This can improve convenience of posting interactive information, improve convenience of user interaction, and further improve user experience.

Based on the descriptions of the method embodiment and the apparatus embodiment, an embodiment of the present disclosure further provides a computer device. Referring to FIG. 11, the computer device includes at least a processor 1101, an input interface 1102, an output interface 1103, and a computer-readable storage medium 1104. The processor 1101, the input interface 1102, the output interface 1103, and the computer-readable storage medium 1104 of the computer device may be connected through a bus or in another manner. The computer-readable storage medium 1104 may be stored in a memory of the computer device. The computer-readable storage medium 1104 is configured to store a computer program. The processor 1101 is configured to execute the computer program stored in the computer-readable storage medium 1104. As a computing core and a control core of the computer device, the processor 1101 (or referred to as a CPU) is suitable for running the computer program to implement a corresponding method procedure or a corresponding function.

In an embodiment, the processor may load and execute the computer program stored in the computer-readable storage medium, to implement a corresponding operation in the method embodiment shown in FIG. 2 or FIG. 5. During specific implementation, the computer program in the computer-readable storage medium may be loaded and executed by the processor to perform the following operations: displaying a media playback interface configured for playing multimedia data; displaying an interactive control when the multimedia data played on the media playback interface satisfies a first condition; and triggering display of at least one piece of first interactive information in response to a trigger operation on the interactive control.

An embodiment of the present disclosure further provides a computer-readable storage medium (memory). The computer-readable storage medium is a memory device of a computer device, and is configured to store a computer program and data. The computer-readable storage medium herein may include a built-in storage medium of the computer device, or may certainly include an extended storage medium supported by the computer device. The computer-readable storage medium provides storage space, and the storage space stores an operating system of the computer device. In addition, a computer program is further stored in the storage space. The computer program is suitable for the processor 1101 to load and execute, to implement a corresponding method procedure provided in the embodiments of the present disclosure. The computer-readable storage medium herein may be a high-speed RAM memory, or may be a non-volatile memory, for example, at least one magnetic disk memory. In some embodiments, the computer-readable storage medium may be at least one computer-readable storage medium located away from the processor.

In this embodiment of the present disclosure, a media playback interface configured for playing multimedia data is displayed, an interactive control is displayed when the multimedia data played on the media playback interface satisfies a first condition, and display of at least one piece of first interactive information is triggered in response to a trigger operation on the interactive control. In other words, interactive information may be conveniently posted based on the interactive control displayed when the multimedia data played on the media playback interface satisfies the first condition. This can improve convenience of posting interactive information, improve convenience of user interaction, and further improve user experience.

An embodiment of the present disclosure provides a computer program product. The computer program product includes a computer program. The computer program is stored in a computer-readable storage medium. A processor of a computer device reads the computer program from the computer-readable storage medium. The processor executes the computer program, so that the computer device executes the method embodiment shown in FIG. 2 or FIG. 5.

According to various embodiments of the present disclosure, the computer device may display the media playback interface, the media playback interface being configured for playing the multimedia data; and display the interactive control when the multimedia data played on the media playback interface satisfies the first condition. As can be seen, the computer device may automatically output the interactive control in response to the multimedia data satisfying the first condition, a viewer object does not need to perform a series of cumbersome and complex operations, and the computer device does not need to consume performance resources to respond to the cumbersome and complex operations. This optimizes a response mechanism of the computer device, reduces a requirement on performance of the computer device, and reduces consumption of the performance resources of the computer device. In addition, automatic output of the interactive control effectively simplifies an interactive information posting procedure. Moreover, the outputted interactive control may further prompt and stimulate the viewer object to trigger the interactive control to post interactive information, increasing an interaction frequency. The computer device triggers display of the at least one piece of first interactive information in response to the trigger operation on the interactive control. In this way, interactive information can be conveniently posted by performing a trigger operation on the interactive control, improving convenience of posting interactive information and improving interactivity.

The embodiments disclosed herein are merely exemplary and are certainly not intended to limit the scope of the claims of the present disclosure. Therefore, equivalent variations made in accordance with the claims of the present disclosure shall fall within the scope of the present disclosure.

What is claimed is:

1. A data processing method, performed by a computer device, the method comprising:
displaying a media playback interface, the media playback interface being configured for playing multimedia data;
displaying an interactive control when the multimedia data played on the media playback interface satisfies a first condition; and
triggering display of at least one piece of first interactive information in response to a trigger operation on the interactive control.

2. The method according to claim 1, wherein that the multimedia data played on the media playback interface satisfies the first condition comprises at least one of following:
the multimedia data comprises preset media content;
the multimedia data is played into a preset playback time;
the multimedia data is played to a preset media segment;
the multimedia data comprises interactive information, and a quantity of pieces of interactive information is greater than a first quantity threshold;
the multimedia data comprises specific interactive information, and the specific interactive information is interactive information comprising specific content information or interactive information transmitted by a specific object; and
the multimedia data comprises the specific interactive information, and a quantity of pieces of specific interactive information is greater than a second quantity threshold.

3. The method according to claim 1, wherein triggering the display of the at least one piece of first interactive information in response to the trigger operation on the interactive control comprises:
triggering display of one piece of first interactive information each time a trigger operation is performed on the interactive control;
triggering, when an operation duration of the trigger operation performed on the interactive control is T, display of one piece of first interactive information each time a time period t is reached within the operation duration T, t and T both being positive integers, and t being less than T;
triggering display of one piece of first interactive information when an operation duration of the trigger operation performed on the interactive control is greater than a first duration threshold; or
triggering display of one piece of first interactive information each time the interactive control is moved to a new location point when the trigger operation is performed on the interactive control and the interactive control is moved along the media playback interface during the trigger operation.

4. The method according to claim 1, further comprising: outputting a quantity of pieces of first interactive information triggered to be displayed; and
the interactive control comprises quick comment content, the first interactive information comprises content information matching the quick comment content, and the content information comprises one or more of: a text, an emoji, an image, and audio.

5. The method according to claim 1, wherein a display manner of the interactive control comprises at least one of following:
displaying the interactive control on the media playback interface in a bullet comment form;
displaying the interactive control at any fixed location on the media playback interface;
displaying the interactive control dynamically at different locations on the media playback interface;
displaying the interactive control by using an interface independent of the media playback interface; or
displaying the interactive control in a window located on the media playback interface.

6. The method according to claim 1, wherein in response to a quantity of interactive controls being M, M being an integer greater than 1, a display manner of the M interactive controls comprises at least one of following:
displaying the M interactive controls on the media playback interface in parallel;
displaying the M interactive controls on the media playback interface in a superimposition manner; or
displaying the M interactive controls sequentially on the media playback interface in a random switching manner.

7. The method according to claim 4, wherein the quantity of pieces of first interactive information is N, N being an integer greater than 1; and
triggering the display of the at least one piece of first interactive information in response to the trigger operation on the interactive control comprises:
displaying, in response to the trigger operation on the interactive control, the N pieces of first interactive information sequentially in different display manners based on a generation sequence of the N pieces of first interactive information,
the different display manners comprising at least one of following: display sizes of different pieces of first interactive information being different, display colors of different pieces of first interactive information being different, display locations of different pieces of first interactive information being different, flow trajectories of different pieces of first interactive information during flowing display being different, display shapes of different pieces of first interactive information being different, and display durations of different pieces of first interactive information being different.

8. The method according to claim 1, wherein the first interactive information is displayed in a flowing manner based on a first flow trajectory, the multimedia data further comprises second interactive information, the second interactive information is interactive information that is not triggered by using the interactive control, and the second interactive information is displayed in a flowing manner based on a second flow trajectory, the first flow trajectory being different from the second flow trajectory.

9. The method according to claim 1, wherein the multimedia data comprises a plurality of viewer objects, the trigger operation on the interactive control is performed by a target viewer object in the plurality of viewer objects, and the method further comprises:
pushing the at least one piece of first interactive information to another viewer object other than the target viewer object.

10. The method according to claim 1, further comprising:
displaying information when the multimedia data played on the media playback interface satisfies a second condition, that the multimedia data played on the media playback interface satisfies the second condition comprising at least one of following:
the multimedia data comprises the first interactive information;
the multimedia data comprises the first interactive information, and the quantity of pieces of first interactive information reaches a third quantity threshold;
the multimedia data comprises the specific interactive information, and the specific interactive information is the interactive information comprising the specific content information or the interactive information transmitted by the specific object;
the multimedia data comprises the specific interactive information, and the quantity of pieces of specific interactive information reaches a fourth quantity threshold; and
the operation duration of the trigger operation performed on the interactive control is greater than a second duration threshold.

11. The method according to claim 10, wherein a display manner of the information comprises at least one of following:
displaying the information in a flowing manner based on a flow trajectory same as that of the interactive information if the interactive information is displayed in a flowing manner;
displaying the information in a flowing manner based on a flow trajectory different from that of the interactive information; or
displaying the information statically or dynamically at any location on the media playback interface at which no interactive information is blocked,
the information being pushed to the plurality of viewer objects of the multimedia data, or the information being pushed to a viewer object in the plurality of viewer objects that has transmitted interactive information.

12. The method according to claim 10, wherein the information is determined based on target interactive information, and the target interactive information comprises the first interactive information or specific interactive information; and
a determining manner of the information comprises:
determining, from a plurality of pieces of copy content based on the target interactive information, copy content matching the target interactive information, and constructing the information based on the determined copy content,
the copy content matching the target interactive information comprising at least one of following: semantics of the copy content matching semantics of content information of the target interactive information; the copy content and the content information of the target interactive information having matching keywords; an emotion expressed by the copy content matching an emotion expressed by the target interactive information; and an item associated with the copy content matching the emotion expressed by the target interactive information.

13. The method according to claim 10, wherein the information is determined based on target interactive information, and the target interactive information comprises the first interactive information or specific interactive information; and
a determining manner of the information comprises:
obtaining, when the multimedia data played on the media playback interface satisfies the second condition, media content played by the multimedia data; and
selecting, from a plurality of pieces of copy content based on the media content played by the multimedia data, copy content matching the media content played by the multimedia data, and constructing the information based on the selected copy content,
the copy content matching the media content played by the multimedia data comprising at least one of following: an emotion expressed by the copy content matching an emotion expressed by the media content played on the multimedia data; and an item associated with the copy content matching the emotion expressed by the media content played on the multimedia data.

14. The method according to claim 10, wherein the information is constructed based on the target interactive information, and the target interactive information comprises the first interactive information or the specific interactive information; and the method further comprises:
adjusting the displayed information dynamically when a quantity of pieces of target interactive information changes;
adjusting the displayed information dynamically when the operation duration of the trigger operation performed on the interactive control increases; and
adjusting the displayed information dynamically when a first feedback operation for the information is detected,
the dynamic adjustment comprising at least one of following: displaying new information instead, adjusting the copy content of the displayed information, adjusting a style of the displayed information, adjusting a display location of the displayed information, and adjusting the display manner of the displayed information.

15. The method according to claim 1, further comprising:
displaying an associated page of the information in response to an interactive operation on the information,
the information comprising at least one of following: advertisement information, game information, and guessing information; the associated page being an advertisement detail page when the information is the advertisement information; the associated page being a game entry page, a game trial page, or a game result page when the information is the game information; and the associated page being a guessing result page when the information is the guessing information.

16. The method according to claim 1, further comprising:
stopping, in response to a bullet comment turn-off operation, displaying the interactive information and the information.

17. The method according to claim 1, further comprising:
receiving a second feedback operation for the interactive information comprised in the multimedia data;
calculating a popularity of each piece of interactive information based on a second feedback operation performed on each piece of interactive information; and
performing, based on the popularity of each piece of interactive information, incentive processing on a viewer object transmitting the corresponding interactive information.

18. A computer device, comprising:
one or more processors and a memory containing a computer program that, when being executed, causes the one or more processors to perform:
displaying a media playback interface, the media playback interface being configured for playing multimedia data;
displaying an interactive control when the multimedia data played on the media playback interface satisfies a first condition; and
triggering display of at least one piece of first interactive information in response to a trigger operation on the interactive control.

19. The computer device according to claim 18, wherein that the multimedia data played on the media playback interface satisfies the first condition comprises at least one of following:
the multimedia data comprises preset media content;
the multimedia data is played into a preset playback time;
the multimedia data is played to a preset media segment;
the multimedia data comprises interactive information, and a quantity of pieces of interactive information is greater than a first quantity threshold;
the multimedia data comprises specific interactive information, and the specific interactive information is interactive information comprising specific content information or interactive information transmitted by a specific object; and
the multimedia data comprises the specific interactive information, and a quantity of pieces of specific interactive information is greater than a second quantity threshold.

20. A non-transitory computer-readable storage medium containing a computer program that, when being executed, causes at least one processor to perform:
displaying a media playback interface, the media playback interface being configured for playing multimedia data;
displaying an interactive control when the multimedia data played on the media playback interface satisfies a first condition; and
triggering display of at least one piece of first interactive information in response to a trigger operation on the interactive control.
